(19) United States
(12) Patent Application Publication
(10) Pub. No.: US 2025/0332786 A1
(43) Pub. Date: Oct. 30, 2025

(54) ADDITIVE MANUFACTURING WITH MATERIAL LAYERS

(71) Applicant: Align Technology, Inc., San Jose, CA (US)

(72) Inventor: Michael Christopher Cole, San Jose, CA (US)

(21) Appl. No.: 19/183,270

(22) Filed: Apr. 18, 2025

Related U.S. Application Data
(60) Provisional application No. 63/636,338, filed on Apr. 19, 2024.

(51) Int. Cl. B29C 64/141; B29C 64/379; B29L 31/00; B33Y 10/00; B33Y 80/00

(52) U.S. Cl. CPC B29C 64/141; B29C 64/379; B33Y 10/00; B29L 2031/753; B33Y 80/00

(57) ABSTRACT

Methods and systems for additive manufacturing are provided. In some embodiments, a method includes forming an object from a plurality of object layers, where each object layer is formed by: depositing a material layer, applying energy to a target portion of the material layer, the target portion of the material layer having a geometry corresponding to the object layer, and forming a cut in the material layer at or near a boundary between the target portion of the material layer and a remaining portion of the material layer. The method can further include, after forming the object from the plurality of object layers, separating the object from excess material along the cut in each material layer.

### CROSS-REFERENCE TO RELATED APPLICATION(S)

The present application claims the benefit of priority to U.S. Provisional Application No. 63/636,338, filed Apr. 19, 2024, which is incorporated by reference herein in its entirety.

### TECHNICAL FIELD

The present technology generally relates to manufacturing, and in particular, to additive manufacturing with material layers.

### BACKGROUND

Additive manufacturing (also known as “3D printing”) includes a variety of technologies which fabricate 3D objects through an additive process. Conventional additive manufacturing processes typically involve building up a 3D object from multiple layers of a material. However, the object geometries produced by conventional additive manufacturing processes are generally limited, e.g., it may be difficult or impossible to create objects with large overhangs, islands, internal cavities, etc. Although temporary supports can be printed with the object to stabilize more complex geometries, it can be time-consuming and labor-intensive to remove the supports without damaging the object. Moreover, it may be challenging to clean excess material from the printed object, particularly if the material is highly viscous (e.g., resin).

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A is a partially schematic cross-sectional view of a system for additive manufacturing of an object, in accordance with embodiments of the present technology.

FIGS. 1B-1G are partially schematic cross-sectional views illustrating operation of the system of FIG. 1A, in accordance with embodiments of the present technology.

FIG. 2A is a partially schematic cross-sectional view of a material layer with an offset cut, in accordance with embodiments of the present technology.

FIG. 2B is a partially schematic cross-sectional view of a material layer with an offset cut, in accordance with embodiments of the present technology.

FIGS. 3A-3C are partially schematic illustrations of a process for modifying a surface of an object, in accordance with embodiments of the present technology.

FIG. 4 is a partially schematic cross-sectional view of an object including an overhang, in accordance with embodiments of the present technology.

FIGS. 5A and 5B are partially schematic cross-sectional views of a process for forming an object with an overhang, in accordance with embodiments of the present technology.

FIGS. 6A and 6B are partially schematic cross-sectional views of a process for forming an object with an overhang, in accordance with embodiments of the present technology.

FIGS. 7A and 7B are partially schematic cross-sectional views of a system including a laterally-positioned cutting mechanism, in accordance with embodiments of the present technology.

FIG. 7C is a partially schematic cross-sectional view of a system including an angled cutting mechanism, in accordance with embodiments of the present technology.

FIG. 8 is a partially schematic cross-sectional view of a system including a cutting mechanism for forming a cut in an object, in accordance with embodiments of the present technology.

FIGS. 9A-9C are partially schematic cross-sectional views of an additive manufacturing process for forming an object including an internal cavity, in accordance with embodiments of the present technology.

FIGS. 10A-10C are partially schematic cross-sectional views of an additive manufacturing process for forming an object including an internal cavity, in accordance with embodiments of the present technology.

FIGS. 11A and 11B are partially schematic illustrations of a system for additive manufacturing of an object, in accordance with embodiments of the present technology.

FIGS. 12A and 12B are partially schematic illustrations of processes for additive manufacturing of an object, in accordance with embodiments of the present technology.

FIGS. 13A and 13B are partially schematic illustrations of processes for additive manufacturing of an object, in accordance with embodiments of the present technology.

FIG. 14 is a partially schematic illustration of a system for additive manufacturing of an object, in accordance with embodiments of the present technology.

FIG. 15A is a flow diagram illustrating a method for fabricating an object, in accordance with embodiments of the present technology.

FIG. 15B is a flow diagram illustrating a method for fabricating an object, in accordance with embodiments of the present technology.

FIG. 16A illustrates a representative example of a tooth repositioning appliance configured in accordance with embodiments of the present technology.

FIG. 16B illustrates a tooth repositioning system including a plurality of appliances, in accordance with embodiments of the present technology.

FIG. 16C illustrates a method of orthodontic treatment using a plurality of appliances, in accordance with embodiments of the present technology.

FIG. 17 illustrates a method for designing an orthodontic appliance, in accordance with embodiments of the present technology.

FIG. 18 illustrates a method for digitally planning an orthodontic treatment and/or design or fabrication of an appliance, in accordance with embodiments of the present technology.

### DETAILED DESCRIPTION

The present technology relates to systems and methods for additive manufacturing of objects from a plurality of material layers. In some embodiments, for example, a method includes forming an object from a plurality of object layers. Each object layer can be formed by depositing a material layer and applying energy to a target portion of the material layer, the target portion of the material layer having a geometry corresponding to the object layer. The applied energy can cure the target portion of the material layer and/or cause the target portion to adhere to a previously deposited material layer (e.g., adhere to a target portion of the previously deposited material layer that corresponds to a previous object layer). Subsequently, a cut can be formed in the material layer at or near a boundary between the target portion of the material layer and a remaining portion of the material layer, e.g., using a laser cutter or other cutting mechanism. After cutting, the remaining portion of the material layer can remain in place to support subsequently deposited material layers. The deposition, energy application, and cutting processes can be repeated until the entire object has been formed. The method can then continue with separating excess (e.g., uncured and/or unadhered) material from the object along the cut in each material layer.

The techniques described herein can provide various advantages compared to conventional additive manufacturing processes. For example, the cuts in the material layers can make it easier to clean excess material from the printed object, particularly if the material is highly viscous and/or would otherwise be highly adherent to the surfaces of the object. Moreover, the present technology allows for complex geometries such as overhangs, islands, interior cavities, etc., since the excess material can remain in place throughout the entire additive manufacturing process to support subsequent layers of the object. Such geometries can be printed without additional support structures for stabilization, thus obviating the need for support removal during post-processing. Furthermore, the present technology can accommodate materials that are not compatible with most conventional additive manufacturing processes (e.g., semicrystalline materials, thermoplastic materials), thus providing greater flexibility in material selection and object properties. The present technology also allows for the embedding of foreign objects into the printed object during the printing process.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Methods and Systems for Additive Manufacturing With Material Layers

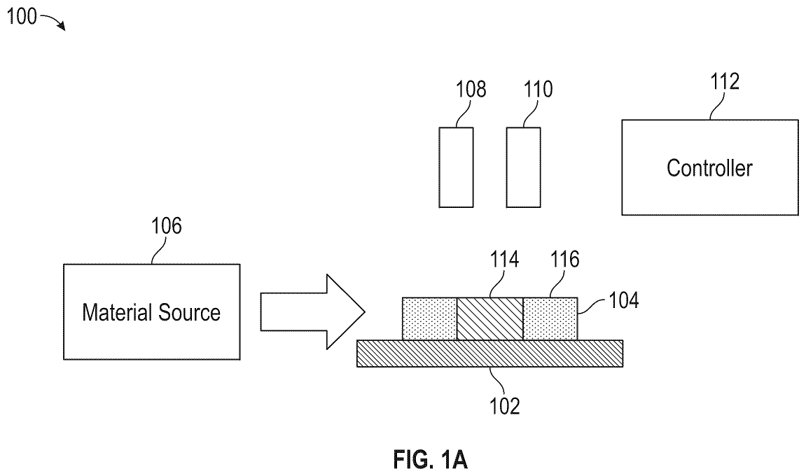

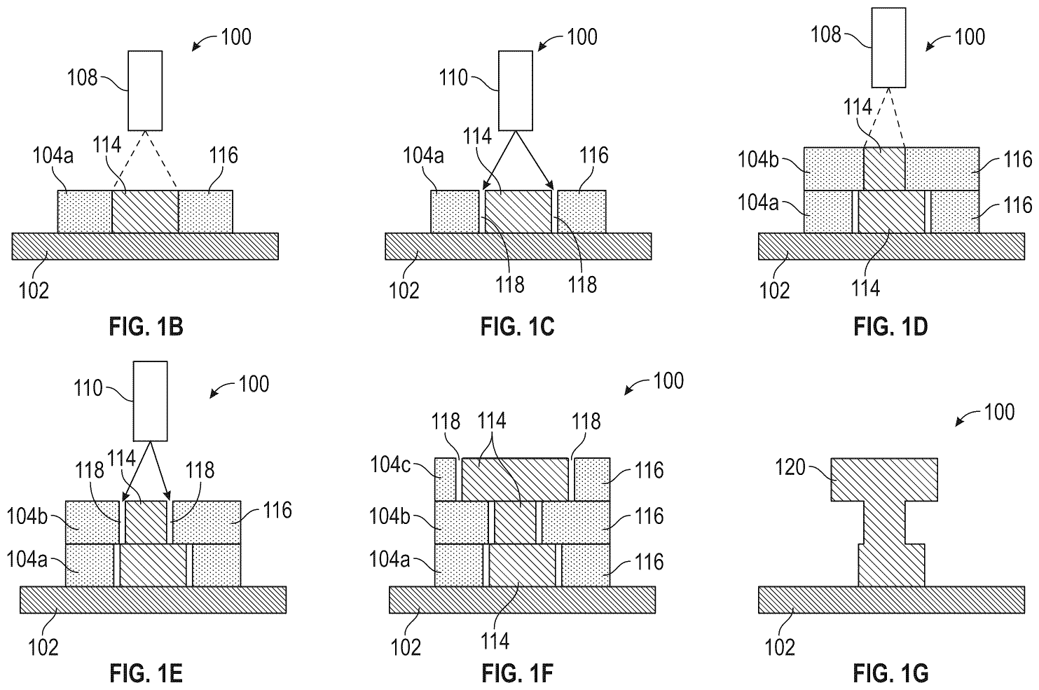

FIGS. 1A-1G provide a general overview of a system 100 for additive manufacturing of an object, in accordance with embodiments of the present technology. Specifically, FIG. 1A is a partially schematic cross-sectional view of the system 100, and FIGS. 1B-1G are partially schematic cross-sectional views illustrating operation of the system 100. The system 100 can be used to fabricate many different types of objects from a plurality of material layers, such as orthodontic appliances (e.g., aligners, palatal expanders, retainers, attachment placement devices, attachments), restorative objects (e.g., crowns, veneers, implants), and/or other dental appliances (e.g., oral sleep apnea appliances, mouth guards). Additional examples of dental appliances and associated methods that are applicable to the present technology are described in Section II below.

Referring first to FIG. 1A, the system 100 includes a build platform 102 configured to support a plurality of material layers 104 (a single material layer 104 is shown merely for purposes of simplicity), a material source 106 configured to deposit the material layers 104 onto the build platform 102 and/or onto previously deposited material layers 104, an energy source 108 configured to output energy toward the deposited material layers 104, a cutting mechanism 110 configured to cut the deposited material layers 104, and a controller 112 configured to control the operations of various components of the system 100. As described in greater detail below in connection with FIGS. 1B-1G, the energy source 108 can selectively apply energy to a target portion 114 of each material layer 104 to form a respective portion of the object, e.g., an individual object layer. In some embodiments, the applied energy causes a change in at least one material property of the target portion 114 (e.g., causes curing, polymerization, sintering, melting, fusing, and/or adhesion to an underlying layer), while leaving a remaining portion 116 of the material layer 104 substantially unaffected. The cutting mechanism 110 can cut into the material layer 104 at or near a boundary between the target portion 114 and the remaining portion 116, thereby facilitating separation of the remaining portion 116 from the target portion 114 during post-processing.

The material layers 104 can each be composed of any suitable material, such as a homogenous material, a composite material, or a mixed phase material. For example, a material layer 104 can be or include a polymeric material, such as a thermoplastic material, a thermoset material, or a combination thereof. Alternatively or in combination, a material layer 104 can be or include a precursor of a polymeric material, such as one more polymerizable components (e.g., monomers, oligomers, and/or reactive polymers). Optionally, a material layer 104 can be made out of a semicrystalline material, and/or can include semicrystalline phases and/or materials. Examples of semicrystalline materials suitable for use in the present technology are described in U.S. Patent Application No. 2021/0147672, the disclosure of which is incorporated by reference herein in its entirety.

The material layers 104 may be composed of materials having any of a variety of different viscosities, as long as the material does not flow substantially during the printing process and can support the material layers 104 above it. For instance, thixotropic materials can be used as long as the shear force or pressure force that causes flow is not reached during the printing process (such as by increased material height and/or motion of the material). In general, the material layer 104 may be composed of any material that functionally behaves as a solid for the duration of the print process, e.g., the material resists flow under shear and/or pressure forces. For semi-solid or fluid materials, the materials can have viscosities of at least 10,000 cP, 100,000 cP, or more at the print temperature (e.g., the temperature at which the material layers 104 are deposited, which may be room temperature (20-25° C.) or higher).

For example, some or all of the material layers 104 can be composed partially or entirely out of a resin. The resin can include one or more polymerizable components, such as one or more monomers, oligomers, and/or reactive polymers. The polymerizable components can be any molecule or compound capable of forming bonds with other polymerizable components, thus resulting in a larger molecule with increased molecular weight. In some embodiments, the bond-forming reaction occurs multiple times, such that the molecular weight of the resultant molecule increases with each successive bond-forming reaction. Examples of bond-forming reactions suitable for use with the techniques described herein include, but are not limited to, free radical polymerization, ionic polymerization (e.g., cationic polymerization, anionic polymerization), condensation polymerization, metathesis polymerization, ring opening polymerization, Diels-Alder reactions, photodimerization, carbene formation, nitrene formation, acetal formation, and suitable combinations thereof.

In some embodiments, the polymerizable components include one or more of the following: an acrylate monomer, a methacrylate monomer, a thiol monomer, a vinyl acetate monomer, a vinyl ether monomer, a vinyl chloride monomer, a vinyl silane monomer, a vinyl siloxane monomer, a styrene monomer, an allyl ether monomer, an acrylonitrile monomer, a butadiene monomer, a norbornene monomer, a maleate monomer, a fumarate monomer, an epoxide monomer, an anhydride monomer, a cyclic ether monomer, a cyclic ester monomer, a cyclic carbonate monomer, a cyclic carbamate monomer, or a hydroxyl monomer. In some embodiments, the polymerizable components include one or more of the following: a free radically polymerizable group, a cationically polymerizable group, or an anionically polymerizable group. In some embodiments, the polymerizable components include one or more reactive functional groups, such as one or more of the following: an acrylate, a methacrylate, an acrylamide, a vinyl group, a vinyl ether, a thiol, an allyl ether, a vinyl silane, an allyl silane, a norbornene, a vinyl acetate, a maleate, a fumarate, a methylenemalonate, a maleimide, an epoxide, a ring-strained cyclic ether, a ring-strained thioether, a cyclic ester, a cyclic carbonate, a cyclic silane, a cyclic siloxane, a hydroxyl, an amine, an isocyanate, a blocked isocyanate, a carboxylic acid, an acid chloride, an activated ester, an oxetane, a Diels-Alder reactive group, a furan, a cyclopentadiene, an anhydride, a group favorable toward photodimerization (e.g., an anthracene, an acenaphthylene, or a coumarin), a group that photodegrades into a reactive species (e.g., Norrish Type 1 and 2 materials), an azide, a derivative thereof, or a combination thereof. Additional examples of polymerizable components that may be used are provided in U.S. Pat. No. 10,495,973 and U.S. Patent Publication Nos. 2021/0147672, 2021/0395420, 2022/0380502, and 2023/0021953, the disclosures of each of which are incorporated by reference herein in their entirety.

As another example, some or all of the material layers 104 can be composed partially or entirely out of a powder (e.g., a powdered polymer such as powdered nylon (e.g., Nylon 12), polyesters, polyethers, polyaramids, polyacrylates, polyalkanes, etc.). In such embodiments, the material layer 104 can be provided as a preformed packed sheet of powder. The powder particles may be lightly adhered to each other using an adherent (e.g., wax, viscous liquid, resin, adhesives, glues, polymers, oligomers, monomers), which may or may not be photoactive. In some embodiments, the powder is lightly pressed with or without heat to partially coalesce some or all of the particles into a solid sheet with or without porosity. In some embodiments, a slurry with high powder loading is made and allowed to form a solid sheet by cooling, polymerizing, and/or solvent evaporation. The use of a preformed packed sheet of powder can provide higher material densities (e.g., compared to conventional powder bed printing processes), which may enhance the material properties of the printed object and, in some embodiments, may reduce or eliminate the porosity that is often present for conventional powder printed objects. This approach can improve handling efficiency (e.g., compared to conventional powder bed printing processes), since no individual powder grains are present and/or no powder leveling step is needed.

Optionally, a single material layer 104 can include multiple sublayers of material and/or can use multiple deposition processes. For instance, a first sublayer can be deposited using a solid sheet transported by a carrier film. After the carrier film is removed, a second sublayer can be deposited on the first sublayer via electrospinning. The first and second sublayers can then be photocured to form a unitary material layer 104. As another example, a first sublayer can be formed via in situ material deposition, then a second sublayer can be formed by depositing a prefabricated material, e.g., either in successive sublayers or in the same sublayer. In some embodiments, the sublayer is selectively deposited only at the regions that will become part of the printed object. Sublayers may be deposited by any material deposition method such as ink jetting, powder dispensing, liquid dispensing, spraying, electrospinning, melt spinning, electro spraying, coating (via brush, roller, or other mechanical contact), etc. Sublayers may add functionality to the printed object, such as by changing the mechanical strength, layer to layer adhesion, color, coefficient of thermal expansion, conductivity, melting temperature, glass transition temperature, modulus, elongation to break, elongation to yield, tear resistance, transparency, and/or other properties.

In some embodiments, some or all of the material layers 104 include one or more additives, such as catalysts, reaction inhibitors, blockers, viscosity modifiers, fillers, fibers, particles, binders, reactive diluents, solvents, pigments and/or dyes, stabilizers, surface-active compounds, surfactants, mold release compounds, biologically active compounds (e.g., pharmaceuticals, enzymes, antibiotics, cells, hormones, antioxidants), inert polymers, inert oligomers, etc., or suitable combinations thereof. Such additives may be incorporated into a material layer 104, for example, as part of a resin that is deposited to form the material layer 104, as part of a sublayer, and/or as part of an adhesion promoter used with the material layer 104.

For example, in some embodiments, the material layer 104 includes a catalyst that, when exposed to energy, forms a reactive species that catalyzes a bond-forming reaction. The catalyst can be a photocatalyst that is activated or otherwise created by absorption of light (e.g., infrared light, visible light, or ultraviolet (UV) light). Examples of photocatalysts include, but are not limited to, photoinitiators (e.g., radical initiators, cationic initiators), photoacid generators, and photobase generators. Alternatively or in combination, the catalyst can be a thermal initiator that is activated by heat.

In some embodiments, the material layer 104 includes a reaction inhibitor and/or retarder to prevent polymerization in locations where curing is not desired. The reaction inhibitor/retarder can be a photoactivated inhibitor/retarder that is activated by light (e.g., infrared light, visible light, UV light), heat, mechanical energy, or other energy source. Optionally, the reaction inhibitor/retarder can be removed from portions of the first material layer 104a where curing is desired, e.g., by degrading the reaction inhibitor/retarder using light or other energy.

In some embodiments, the material layer 104 includes a blocker that limits the depth of energy penetration into the material layer 104 during the additive manufacturing process. For example, the blocker can be a photoblocker that absorbs the irradiating wavelength responsible for causing photoreactions (e.g., activation of a photocatalyst or photodimerization reaction). In some embodiments, the photoblocker is activated or deactivated by an energy source, such as light (e.g., spiropyrans and other photochromics that are activated by light and change their absorption). Alternatively or in combination, photobleaching can also be used to prevent curing in a given region until a specified dose or intensity of light is provided. In other embodiments, however, the material layer 104 does not include any blockers.

In some embodiments, the material layer 104 includes a viscosity modifier. The viscosity modifier can be a component that increases the viscosity of the material layer 104 (e.g., a filler, binder, thixotropic agent). Alternatively, the viscosity modifier can be a component that decreases the viscosity of the material layer 104 (e.g., reactive diluent, solvent, plasticizer). In some embodiments, the viscosity modifier is activated by heat, light, or other energy source. Such viscosity modifiers may be solid at room temperature but become active at an elevated temperature, such as the print temperature and/or a post-processing (e.g., annealing) temperature. At an elevated temperature or upon exposure to light, the viscosity modifier, such as a plasticizer, can cause slight melting, partial melting, partial flow, or full melting type of behavior in the material layer 104.

In some embodiments, the material layer 104 includes a filler. The filler can be an organic or inorganic filler, such as fumed silica, core-shell particles, talc, titanium dioxide, sugar, nanocellulose, graphite, carbon black, carbon nanotubes, glass fibers, organic polymer fibers (e.g., nylon, Kevlar, Nomex, polyether ether ketone (PEEK), ultra-high molecular weight polyethylene (UHMWPE), silk, or other polymers), etc.

In some embodiments, the material layer 104 includes a binder. The binder can be a high molecular weight polymer that is added to the material layer 104 to increase the viscosity and/or to enhance various material properties after curing, such as polymethylmethacrylate, acrylonitrile butadiene styrene (ABS), polystyrene, polyesters, polyethers, starch, poly(vinyl alcohol), etc.

In some embodiments, the material layer 104 includes a reactive diluent. The reactive diluent can decrease the viscosity of the material layer 104, while also reacting with one or more other components to form part of the object. For example, reactive diluents can be combined with oligomers and/or reactive polymers within the material layer 104. In some embodiments, the reactive diluent is a solid at room temperature and melts during lamination of material layers 104, just before or during light irradiation, or during a post-processing operation after the printing process.

In some embodiments, the material layer 104 includes a solvent. The solvent can decrease the viscosity of the material layer 104 and/or compatibilize two or more components of the material layer 104.

In some embodiments, the material layer 104 includes a pigment and/or dye. The pigment and/or dye (e.g., titanium dioxide, red dye #40, carbon black) can add color and/or other function to the object. The dye may absorb the light used to print or may be transparent to the light.

In some embodiments, the material layer 104 includes a stabilizer configured to stabilize one or more components (e.g., to prevent precipitation, aggregation, degradation). For example, the stabilizer can be an emulsifier that stabilizes the components of an emulsion.

In some embodiments, the material layer 104 includes a surface-active compound. The surface-active compound can enhance wetting or adhesion of the material layer 104 to another surface (e.g., to the build platform 102 and/or to subsequently deposited material layers). Alternatively or in combination, the surface-active compound can facilitate debonding of the material layer 104 from another surface. Examples or surface-active compounds include, but are not limited to, wax, silicone compounds, silanes, fluorinated compounds, etc. The surface-active compound can be inert or can have reactive groups that react with the material layer 104 (e.g., during printing and/or after printing).

Optionally, some or all of the components of the material layer 104 can serve more than one function. For example, reactive diluents can be monomers and can also serve as viscosity modifiers; carbon black can be a pigment and also a photoblocker; and so on.

In some embodiments, the material layer 104 is composed partially or entirely out of a material that is easily cuttable by the cutting mechanism 110. For instance, in embodiments where the cutting mechanism 110 cuts into the material layer 104 via ablation, the material layer 104 can be made out of a material that is easily ablatable (e.g., via laser ablation, thermal ablation, and/or mechanical ablation). Such materials can include, for example, materials that easily depolymerize and/or break into smaller molecules upon exposure to ablation energy (e.g., light and/or thermal energy). Materials that depolymerize may be recovered as monomers and reused. In some embodiments, the material includes photodegradable groups in polymer or oligomer chains that are activated by the ablation energy (e.g., via two or three photon absorption).

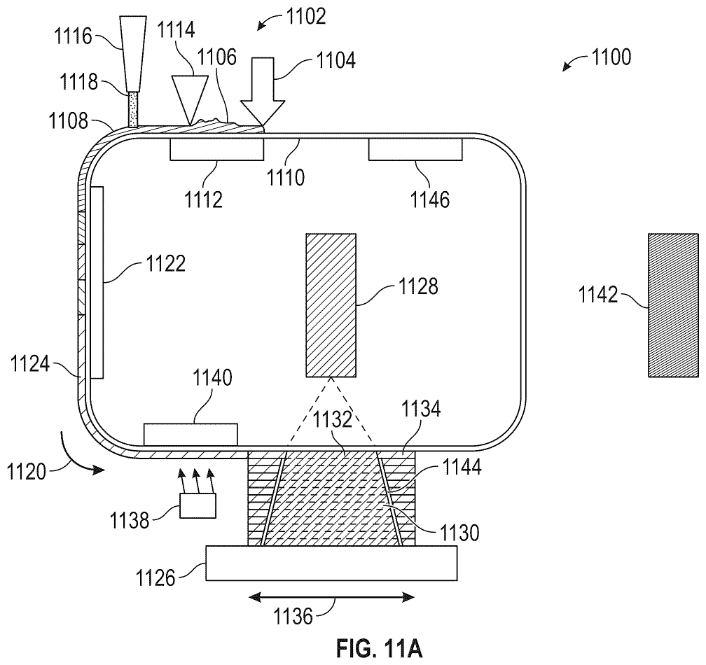

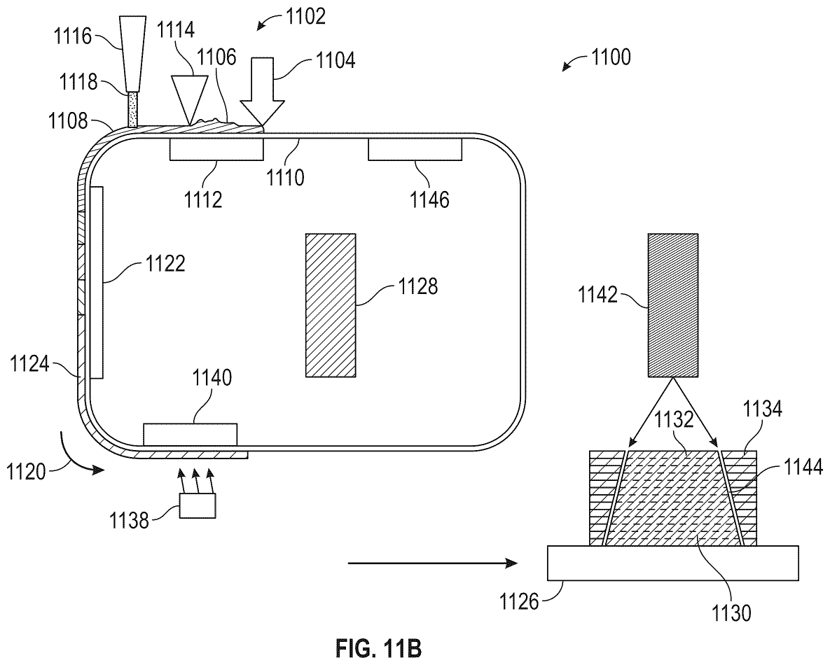

In some embodiments, the material layers 104 are prefabricated before being deposited onto the build platform 102, e.g., using techniques such as solvent casting, doctor blading, extrusion, spray coating, heat pressing, etc. In such embodiments, the material layers 104 can be provided as discrete components (e.g., discrete sheets, films, membranes), and the material source 106 can include a robotic assembly (e.g., a pick-and-place mechanism) or other suitable device that places the discrete components onto the build platform 102. Alternatively, the material layers 104 can be provided as a part of a larger continuous component (e.g., a continuous roll of material), and the material source 106 can include a feed roll, conveyor, etc., that circulates the continuous component onto the build platform 102. The material layer 104 can be provided in any size and shape suitable for forming the object, e.g., the material layer 104 may be rectangular, oval, circular, irregular, etc., as desired. A prefabricated material layer 104 can be provided free standing or supported by another component (e.g., a carrier film). Additional details of methods and systems for prefabricated material layers are discussed below in connection with FIGS. 11A-13B.

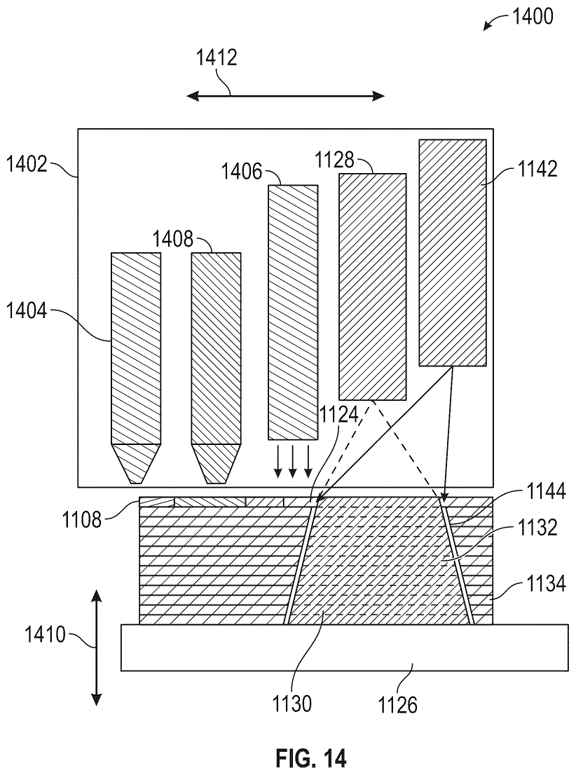

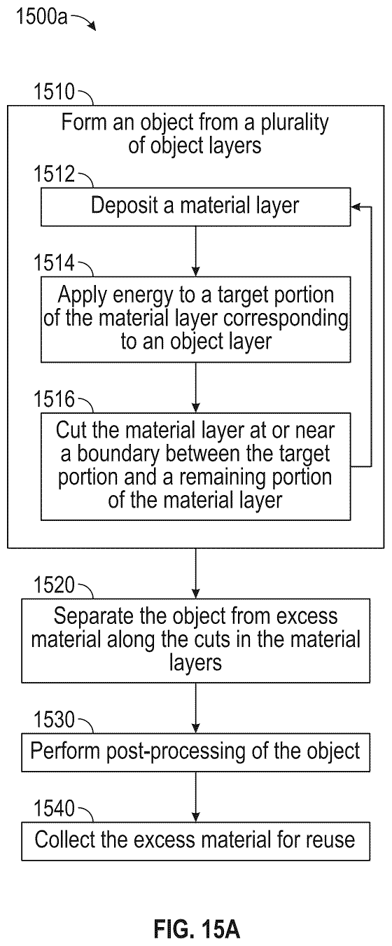

In some embodiments, the material layers 104 or sublayers are formed in situ on the build platform 102, e.g., using techniques such as extrusion (e.g., die extrusion), solvent casting, spraying (e.g., electrostatic spraying), powder deposition (e.g., electrostatic powder deposition), electrospinning, ink jetting, pulsed liquid deposition (e.g., PICO Pμlse), etc. In such embodiments, the material source 106 can include reservoirs (e.g., vats), applicators (e.g., extruders, nozzles, sprayers, inkjets), smoothing devices (e.g., doctor blades, recoaters, rollers), heating devices, cooling devices, and/or other suitable components for in situ fabrication of the material layers 104. In embodiments where a solvent is used in the deposition process of a material layer 104, the solvent may or may not be fully removed before deposition of subsequent material layers 104. In embodiments where a powder is used in the deposition of a material layer 104, the powder can be melted (e.g., by heat and/or solvent) before deposition of subsequent material layers 104. Additional details of methods and systems for fabricating material layers in situ are discussed below in connection with FIG. 14.

The material layers 104 can each independently have any suitable thickness (layer height), such as a thickness within a range from 10 μm to 2 mm, 10 μm to 1 mm, 10 μm to 500 μm, 10 μm to 200 μm, 10 μm to 100 μm, 10 μm to 50 μm, 50 μm to 2 mm, 50 μm to 1 mm, 50 μm to 500 μm, 50 μm to 200 μm, 50 μm to 100 μm, 100 μm to 2 mm, 100 μm to 1 mm, 100 μm to 500 μm, 100 μm to 200 μm, 200 μm to 2 mm, 200 μm to 1 mm, 200 μm to 500 μm, 500 μm to 2 mm, 500 μm to 1 mm, or 1 mm to 2 mm. Some or all of the material layers 104 can have the same thickness, or some or all of the material layers 104 can have different thicknesses. The thickness of an individual material layer 104 can be selected based on the desired thickness for the corresponding object layer, the desired resolution for the object layer (e.g., thinner material layers 104 can be used when higher resolution is desired, such as for more detailed portions of the object), the overall print time for the object (e.g., thicker material layers 104 can reduce print time), the resolution of the cutting mechanism 110, and/or other relevant factors. In some embodiments, the techniques herein may be used in large scale applications for printing of very large objects, in which case the scale of the material layers 104 can be increased to match the scale of the print, as long as the cutting mechanism 110 is capable of cutting partially or entirely through the material layers 104 (e.g., lasers, water jets, and milling devices are able to achieve cutting depths on the order of several inches, depending on the type of material used).

FIGS. 1B-1G illustrate a process for additive manufacturing of an object using the system 100 (certain components of the system 100 are omitted from FIGS. 1B-1G merely for purposes of simplicity). Referring first to FIG. 1B, in an initial stage of operation, a first material layer 104a is deposited onto the build platform 102 (e.g., by the material source 106—not shown). The first material layer 104a can be in a solid or semi-solid state, e.g., the first material layer 104a maintains its initial shape after deposition on the build platform 102 without flowing or deforming. For example, in embodiments where the first material layer 104a is composed partially or entirely out of a resin, the resin can be deposited onto the build platform 102 at a sufficiently low temperature so that the resin behaves as a solid or semi-solid material (e.g., a temperature less than or equal to 300° C., 250° C., 200° C., 150° C., 100° C., 80° C., 60° C., 50° C., 40° C., 30° C., 25° C., 20° C., 15° C., 10° C., 5° C., or 0° C.). Optionally, a cooling device can be used to cool the resin to the desired temperature, e.g., as discussed further below in connection with FIGS. 11A-14. As another example, in embodiments where the first material layer 104a is composed partially or entirely out of a powder, the powder can be prepacked into a unitary solid sheet. The first material layer 104a can be provided in a prefabricated state or can be formed in situ, as discussed herein.

After the first material layer 104a is deposited, the energy source 108 applies energy to the first material layer 104a to form a first layer of the object (“first object layer”). The energy source 108 can be or include a laser, projector, light engine, LED, flash tube, digital micromirror device, or suitable combinations thereof. The energy source 108 can be in a fixed position relative to the build platform 102, or may be movable relative to the build platform 102 (e.g., rotatable and/or translatable). Although the energy source 108 is depicted as being positioned above the material layer 104a, the energy source 108 may alternatively include be positioned at a different location relative to the material layer 104a, such as at a lateral side of the material layer 104a or below the material layer 104a. Additionally, although the energy source 108 is shown as being vertically oriented to output energy vertically downward, the energy source 108 may alternatively be angled to output energy in an angled direction that is offset from vertical.

The energy produced by the energy source 108 can include electromagnetic energy, such as light energy (e.g., UV light, visible, light, infrared light), thermal energy, microwave energy, x-ray energy, ultrasonic energy, ionizing radiation, or a combination thereof. The wavelength of the energy can be within a range from 200 nm to 10 mm, 200 nm to 3 mm, 200 nm to 800 nm, for example. The energy parameters (e.g., intensity, exposure time, wavelength, grayscale value) can be varied as desired, e.g., depending on the desired characteristics for the first object layer.

The energy can cause a change in state of a target portion 114 of the first material layer 104a, while the remaining portions 116 of the first material layer 104a are substantially unaffected (e.g., remain in their initial state). The target portion 114 can have a geometry corresponding to the first object layer (e.g., the size and shape of the target portion 114 can be identical or generally similar to the desired cross-sectional geometry of the first object layer). The remaining portions 116 can correspond to excess material that is not intended to become part of the final object. In some embodiments, the remaining portions 116 are reusable, e.g., in a subsequent additive manufacturing process.

For example, in embodiments where the first material layer 104a includes a curable material (e.g., a polymerizable resin), the energy can cause curing (e.g., polymerization and/or crosslinking) of the target portion 114 of the first material layer 104a, while remaining portions 116 of the first material layer 104a remain substantially uncured. The curing can involve increasing the degree of polymerization and/or crosslinking so the target portion is solvent resistant, melt resistant, and/or fully thermoset. The curing can involve polymerization of one or more polymerizable components of the first material layer 104a, e.g., via photodimerization, photoisomerization, photocyclization, and/or other photoreactions that trigger a change in the material property of the target portion 114.

As another example, the energy can cause sintering, fusing, melting, and/or a phase transition of the target portion 114. In some embodiments, the energy causes melting of the target portion 114, and the melting may be an annealing step that causes crystallization and/or change from a first crystalline form to a second crystalline form (e.g., the second crystalline form may have a higher melting point than the first crystalline form). In yet another example, the energy can cause the target portion 114 to change from being meltable and/or dissolvable in a solvent to being non-meltable and/or non-dissolvable in a solvent. Optionally, the energy can cause the target portion 114 to be changeable from a meltable and/or dissolvable state to a non-meltable and/or non-dissolvable state in a subsequent post-processing operation.

In some embodiments, the energy is selectively applied to the target portion 114, such that the remaining portion 116 is not exposed to the energy. Selective application of the energy can be achieved, for example, via scanning of the energy along a desired path (e.g., similar to stereolithography), projection of the energy in a desired pattern (e.g., similar to digital light processing), masking of the energy, etc. In other embodiments, the energy is applied by contact.

In some embodiments, the energy is applied to the entirety of the first material layer 104a, but the target portion 114 includes an activating agent that causes a change in state of the target portion 114 upon exposure to the energy, while the remaining portions 116 do not include the agent and therefore remain substantially unaffected even when exposed to the energy. The activating agent can be, for example, a catalyst that causes a reaction upon exposure to the energy, such as a photoinitiator, a thermal initiator, an acid, a latent acid, a base, a latent base, a transition metal, a Grubb's derived catalyst, a thermal energy absorber, a microwave absorber, an optical light absorber, etc. The activating agent can be selectively deposited onto and/or into the target portion 114 before the energy is applied to the first material layer 104a, e.g., using ink jetting, spraying, extruding, pulsed liquid deposition (e.g., PICO Pμlse), powder deposition, contact transfer, and/or other suitable material deposition techniques. In such embodiments, the system 100 can further include an applicator (e.g., a nozzle, sprayer, extruder, ink jet) for selective deposition of the activating agent.

In some embodiments, the energy is applied to the entirety of the first material layer 104a, the remaining portions 116 include an inhibiting agent that inhibits a change in state of the remaining portions 116 upon exposure to the energy, while the target portion 114 does not include the agent. The inhibiting agent can be, for example, a reaction inhibitor (e.g., a polymerization inhibitor) or an energy blocker (e.g., a photoblocker). The inhibiting agent can be selectively deposited onto and/or into the remaining portions 116 before the energy is applied to the first material layer 104a, e.g., using ink jetting, spraying, extruding, pulsed liquid deposition (e.g., PICO Pμlse), powder deposition, and/or other suitable material deposition techniques. In such embodiments, the system 100 can further include an applicator (e.g., a nozzle, sprayer, extruder, ink jet) for selective deposition of the inhibiting agent.

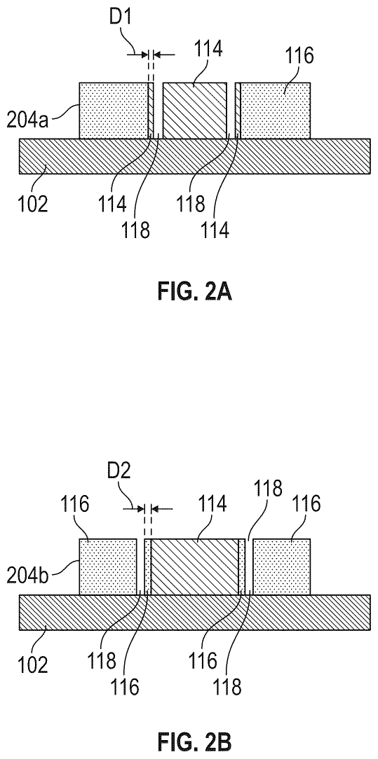

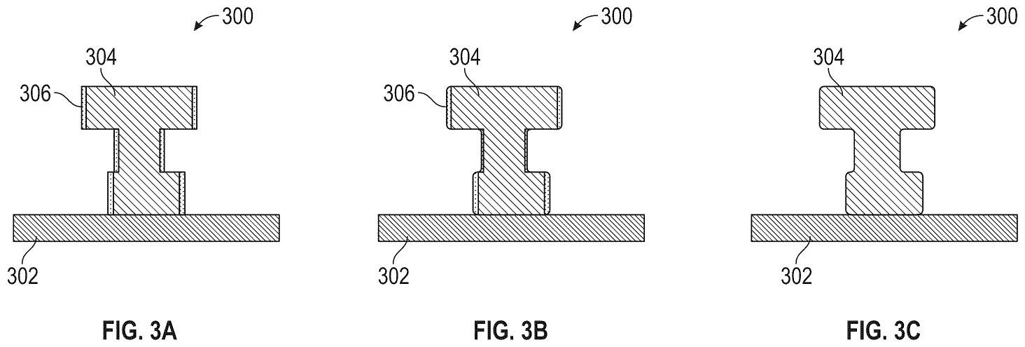

Referring next to FIG. 1C, in a subsequent stage of operation of the system 100, the cutting mechanism 110 is used to form at least one cut 118 in the first material layer 104a. The cut 118 can be located at or near the boundary between the target portion 114 and the remaining portions 116 of the first material layer 104a to create a space, gap, groove, channel, etc., between the target portion 114 and the remaining portions 116. In some embodiments, the cut 118 is located at the boundary, while in other embodiments, the cut 118 is proximate to the boundary, e.g., as discussed below in connection with FIGS. 2A-3C. The cut 118 can generally follow the outline of the first object layer to separate the first object layer from excess material that is not intended to become part of the final object. The dimensions of the cut 118 can be varied as desired, e.g., depending on the type of cutting mechanism 110 used, the thickness of the first material layer 104a, the composition of the first material layer 104a, the desired resolution for the first object layer, etc. In some embodiments, the height or depth of the cut 118 is the same as the thickness (layer height) of the first material layer 104a or is similar to the thickness of the first material layer 104a (e.g., within 25%, 20%, 15%, 10%, 5%, 2%, or 1% of the thickness). The width of the cut 118 can vary from a fraction of the layer height to multiples of the layer height, and can be selected based on the resolution for the printed object (e.g., a smaller cut width may produce higher spatial resolution).

The cutting mechanism 110 can be any device suitable for forming the cut 118. In some embodiments, for example, the cutting mechanism 110 includes a second energy source that applies second energy to the first material layer 104a to form the cut 118. For example, the cutting mechanism 110 can be a laser cutter (e.g., a CO₂ laser, a blue wavelength laser, an ultraviolet laser) that produces one or more laser beams that cut into the first material layer 104a via ablation, melting, vaporization, degradation, depolymerization, etc. Laser cutting can provide relatively high cutting speeds to reduce the overall print time for the object. Alternatively or in combination, the cutting mechanism 110 can use other types of processes to form the cut 118, such as blade cutting, blasting (e.g., sand blasting, water jet), milling, or suitable combinations thereof. For cutting processes that may leave debris (e.g., milling, blasting), an additional debris removal process may be performed after cutting to clean the debris from the first material layer 104a and/or the build platform 102 to avoid interfering with subsequently deposited material layers. Such debris removal processes may include, for example, air jetting, water jetting, vacuuming, wiping, and/or brushing of the first material layer 104a and/or the build platform 102. The cutting mechanism 110 can be in a fixed position relative to the build platform 102, or may be movable relative to the build platform 102 (e.g., rotatable and/or translatable).

Referring next to FIG. 1D, which illustrates a subsequent stage of operation of the system 100, a second material layer 104b is deposited onto the first material layer 104a (e.g., by the material source 106—not shown). The second material layer 104b can have any of the characteristics described above in connection with the first material layer 104a, and the deposition process for the second material layer 104b can include any of the techniques described above in connection with the deposition process for the first material layer 104a. In some embodiments, the second material layer 104b has the same composition, thickness, and/or deposition process as the first material layer 104a, while in other embodiments, the second material layer 104b may have a different composition, thickness, and/or deposition process than the first material layer 104a. The second material layer 104b can be provided in a prefabricated state or can be formed in situ, as discussed herein.

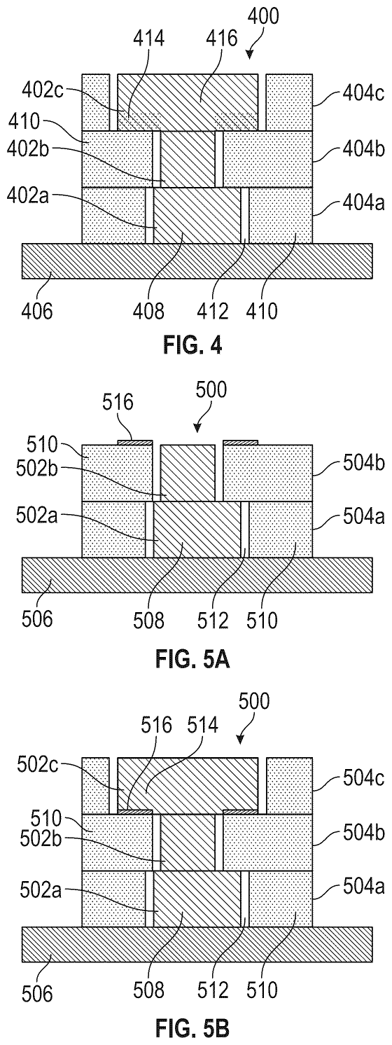

In some embodiments, the second material layer 104b is deposited in a solid or semi-solid state, e.g., the second material layer 104b can maintain its initial shape after deposition on the first material layer 104a without flowing or deforming. The first material layer 104a, including the target portion 114 and the remaining portions 116, can remain in place on the build platform 102 to support the second material layer 104b. This approach can allow for more complex object geometries to be formed in the second material layer 104b, such as overhangs, islands, etc., without requiring support structures, e.g., as described further below in connection with FIGS. 4-6B.

In some embodiments, the second material layer 104b is deposited on the first material layer 104a in a manner that produces few or no bubbles between the second material layer 104b and the first material layer 104a. For example, mechanical force can be applied to the second material layer 104b during and/or after deposition of the second material layer 104b to press the second material layer 104b against the first material layer 104a to drive out air, e.g., via a roller, plate, window, or other suitable device. Optionally, the first material layer 104a and/or the second material layer 104b can be heated to a temperature at or near their melting point, such that the applied force causes the layers 104a, 104 to partially or fully melt, which can enhance wetting of the interfacial surface. In such embodiments, heating may be performed before, during, and/or after the force is applied, and may be applied using electromagnetic energy, ultrasonic energy, direct contact with heated objects, hot air streams, and/or other suitable heating techniques. As another example, a wetting agent can be applied to the first material layer 104a and/or the second material layer 104b to facilitate interlayer adhesion without air bubbles. The wetting agent may be a bonding agent (e.g., a welding agent), as discussed further below. In a further example, the deposition of the second material layer 104b can be performed in a reduced pressure environment (e.g., under vacuum), which can prevent air pockets from forming since less or no air is present.

In some embodiments, the interlayer adhesion and/or wetting between the first material layer 104a and the second material layer 104b is relatively weak, such that the layers 104a, 104b can easily be pulled apart or debonded, e.g., via mechanical forces and/or with a solvent. The interlayer adhesion between the first material layer 104a and the second material layer 104b can be selectively strengthened only at areas corresponding to the object geometry, e.g., upon exposure to light and/or heat energy during printing and/or post-curing, as described further herein.

As shown in FIG. 1D, after the second material layer 104b is deposited, the energy source 108 applies energy to the second material layer 104b to form a second layer of the object (“second object layer”). The energy application process for the second object layer can include any of the techniques described above in connection with the first object layer. For example, the energy can cause a change in state of a target portion 114 of the second material layer 104b (e.g., curing, sintering, fusing, melting, phase transition, increased resistance to heat and/or solvent), while the remaining portions 116 of the second material layer 104b are substantially unaffected. In some embodiments, the energy is selectively applied to the target portion 114 of the second material layer 104b. Alternatively, the energy may be applied to the entirety of the second material layer 104b, in which case the target portion may include an activating agent and/or the remaining portion may include an inhibiting agent, as described elsewhere herein.

The target portion 114 can have a geometry corresponding to the second object layer (e.g., the size and shape of the target portion 114 can be identical or generally similar to the desired cross-sectional geometry of the second object layer). The remaining portions 116 can correspond to excess material that is not intended to become part of the final object. In some embodiments, the remaining portions 116 are reusable, e.g., in a subsequent additive manufacturing process. Some or all of the energy parameters can be the same as the energy parameters used for the first object layer, or some or all of the energy parameters can be different than the energy parameters used for the first object layer.

In some embodiments, the applied energy causes the target portion 114 of the second material layer 104b to adhere to a portion of the first material layer 104a, while the remaining portions 116 of second material layer 104b remains unadhered or weakly adhered to the first material layer 104a. For example, the applied energy can cause the target portion 114 of the second material layer 104b to adhere to the target portion 114 of the first material layer 104a. The target portion 114 of the second material layer 104b may remain unadhered or weakly adhered to the remaining portions 116 of the first material layer 104a. The remaining portions 116 of the second material layer 104b may remain unadhered or weakly adhered to the first material layer 104a, e.g., to the target portion 114 and the remaining portions 116 of the first material layers 104a. As described herein, the interlayer adhesion between the second material layer 104b and the first material layer 104a can be relatively weak in the absence of applied energy, and can be selectively strengthened at locations corresponding to the desired object geometry when energy is applied by the energy source 108.

For example, in embodiments where the second material layer 104b includes a curable material (e.g., a polymerizable resin), the energy can cause curing (e.g., polymerization and/or crosslinking) of the target portion 114 of the second material layer 104b to adhere the target portion 114 of the second material layer 104b to the target portion 114 of the first material layer 104a. As another example, the energy cause melting, fusing, and/or sintering of the target portion 114 of the second material layer 104b to adhere to the target portion 114 of the second material layer 104b to the target portion 114 of the first material layer 104a.

Optionally, the energy can activate a bonding agent that causes the target portion 114 of the second material layer 104b to adhere to the target portion 114 of the first material layer 104a. The bonding agent (e.g., a welding agent) can be an adhesive, gel, liquid, powder, sheet, mixture, solvent, resin, or other substance that bonds, welds, or otherwise adheres the first material layer 104a to the second material layer 104b, e.g., upon exposure to the energy from the energy source 108. For instance, the bonding agent can be activated by light energy (e.g., UV light, visible, light, infrared light), thermal energy, microwave energy, x-ray energy, or a combination thereof. Examples of bonding agents include infrared absorbers, dyes, pigments, and solvents (e.g., in embodiments where the first material layer 104a and the second material layer 104b include thermoplastic materials or materials that are able to melt while in the non-cured state). Some examples of energy-activated bonding agents include carbon black, azobenzene dyes, metal particles, and laser absorbing dyes. In some embodiments, the energy provided to cause bonding of two layers is separate from the energy used to initiate cure or change of material in target region 114. The strength of the adhesion produced by the bonding agent can be greater than or equal to the strength of the material of the layers 104a, 104b, e.g., the interlayer adhesion strength is the same as or stronger than the intralayer material strength. In some embodiments, the adhesion produced by the bonding agent is at full strength after exposure to the energy from the energy source 108, while in other embodiments, the adhesion produced by the bonding agent may not reach full strength during or after post-curing of the object. In some embodiments, the bonding agent does not need to be activated by an energy source, such as in cases where the bonding agent is a solvent or plasticizer. In such embodiments, the solvent or plasticizer can be applied either on the whole material layer or more preferentially on the target portion 114 of the material layer that corresponds to the next material layer to be added.

In embodiments where a bonding agent is used, the bonding agent can be applied to the first material layer 104a and/or the second material layer 104b before the energy is applied. For instance, the bonding agent may be applied to the first material layer 104a before the second material layer 104b is deposited onto the first material layer 104a, the bonding agent may be applied to the second material layer 104b before the second material layer 104b is deposited onto the first material layer 104a, or both. The bonding agent can be applied using any suitable technique, such as ink jetting, spraying, extruding, pulsed liquid deposition (e.g., PICO Pμlse), powder deposition, electrostatic-based techniques, contact techniques, and/or other suitable material deposition techniques. In such embodiments, the system 100 can include an applicator for the bonding agent, such as one or more extruders, nozzles, sprayers, inkjets, etc.

In some embodiments, the bonding agent is selectively applied only to the locations where adhesion between the first material layer 104a and the second material layer 104b is desired (e.g., to the target portion of the second material layer 104b and/or to the target portion 114 of the first material layer 104a), and the energy source 108 can apply energy to the entirety of the second material layer 104b. Alternatively, the bonding agent can be applied to the entirety of the first material layer 104a and/or the second material layer 104b, and the energy source 108 can selectively apply energy to the second material layer 104b at locations where adhesion to the first material layer 104a is desired (e.g., to the target portion 114 of the second material layer 104b only).

Optionally, the second material layer 104b can be adhered to the first material layer 104a using a bonding agent that does not require energy from the energy source 108 or other energy source for activation. For instance, the bonding agent can be a binder for a powder-based material that enhances interlayer adhesion when deposited, without requiring a curing process. Another example is if the bonding agent is a plasticizer, solvent, and/or adhesive that is applied onto the surface via ink jetting or other suitable material deposition techniques. In such embodiments, the bonding agent may be selectively deposited only at the locations where adhesion between the first material layer 104a and the second material layer 104b is desired, and the energy application process may be omitted (e.g., similar to solvent welding).

Referring next to FIG. 1D, in a subsequent stage of operation of the system 100, the cutting mechanism 110 is used to form at least one cut 118 in the second material layer 104b. The cutting process for the second material layer 104b can include any of the techniques described above in connection with the first material layer 104a. For example, the cut 118 can be located at or near the boundary between the target portion 114 and the remaining portions 116 of the second material layer 104b to create a space, gap, groove, channel, etc., between the target portion 114 and the remaining portions 116. The cut 118 can generally follow the outline of the second object layer to separate the second object layer from excess material that is not intended to become part of the final object.

The dimensions of the cut 118 can be varied as desired, e.g., depending on the type of cutting mechanism 110 used, the thickness of the second material layer 104b, the composition of the second material layer 104b, the desired resolution for the first object layer, etc. In some embodiments, the height or depth of the cut 118 is the same as the thickness (layer height) of the second material layer 104b or is similar to the thickness of the second material layer 104b (e.g., within 25%, 20%, 15%, 10%, 5%, 2%, or 1% of the thickness). For example, the cut 118 may extend through the entire second material layer 104b and slightly into the first material layer 104a, e.g., by no more than 20%, 10%, 5%, 2%, or 1% of the thickness of the first material layer 104a. Alternatively, the cut 118 may only extend partially through the second material layer 104b, e.g., the depth of the cut 118 may be no more than 99%, 98%, 95%, 90%, or 80% of the thickness of the second material layer 104b.

Referring next to FIG. 1F, the deposition, energy application, and cutting processes described herein may be repeated with additional material layers 104 (e.g., a third material layer 104c), until the entire object geometry has been formed. Although the illustrated embodiment depicts three material layers 104, an object can include any suitable number of material layers 104, such as 5, 10, 20, 50, 100, 200, 500, or more material layers 104. Each material layer 104 can include a respective target portion 114 corresponding to a respective object layer, and one or more remaining portions 116 that are separated from the target portion 114 via cuts 118. The deposition, energy application, and cutting processes may be dynamically adjusted for each material layer 104, e.g., depending on the desired characteristics (e.g., composition, size, properties) for the corresponding object layer.

Referring next to FIG. 1G, once the entire object geometry has been fabricated, the printed object 120, which encompasses the target portions 114 of each of the material layers 104, can be separated from excess material, which encompasses the remaining portions 116 of each of the material layers 104. The material removal process can be performed using any suitable technique, such as manual removal by a human operator, removal via mechanical forces (e.g., via a blade, scraper, brush, centrifuge, shaker, tumbler), removal via solvents, removal via melting, or suitable combinations thereof. The presence of the cuts 118 in the material layers 104 can facilitate removal of the excess material from the object 120, which may be advantageous in embodiments where the excess material tends to stick to the object 120 (e.g., due to high viscosity). For instance, the cuts 118 may allow the majority of the excess material to be removed (e.g., at least 80%, 90%, 95%, or 99% by mass), e.g., without requiring solvents, large mechanical stresses (e.g., high speed centrifugation), and/or other techniques that might otherwise damage the object 120. Moreover, the interlayer adhesion between the target portions 114 of adjacent material layers 104 can be sufficiently strong to maintain the integrity of the object 120 during the material removal process, whereas the interlayer adhesion between the remaining portions 116 of adjacent material layers 104 can be relatively weak so the remaining portions 116 can be separated from the remaining portions 116 and/or target portions 114 of adjacent material layers 104 without damaging the object 120.

In some embodiments, the excess material removed from the object 120 (which includes the remaining portions 116 of the material layers 104) is collected and/or processed for reuse. The excess material may be reusable with minimal processing. The processing may include, for example, grinding or pelletizing the excess material, (e.g., so the material can be reformed into new sheets and/or re-extruded in situ), heating, melting, filtering, dissolving in a solvent, washing in a non-dissolving solvent, or suitable combinations thereof.

Subsequently, the object 120 may undergo one or more additional process steps, also referred to herein as “post-processing.” Post-processing can include removing additional excess material, post-curing, annealing (e.g., thermal and/or temporal annealing), light exposure, surface modifications, milling, and/or washing.

For example, any excess material that remains on or within the object 120 after the initial material removal process may be removed using various techniques, such as by exposing the object 120 to a solvent (e.g., via spraying, immersion, vapor), heating or cooling the object 120, applying a vacuum to the object 120, blowing a pressurized gas onto the object 120, applying mechanical forces to the object 120 (e.g., vibration, agitation, centrifugation, tumbling, brushing), and/or other suitable techniques. In some embodiments, laser ablation, water jet cutting, milling and/or other subtractive methods of material removal are used (e.g., similar to the techniques used for the cutting process). In some embodiments, relatively little excess material remains on the object 120, such that the additional material removal process can be shortened, simplified, or even omitted altogether.

In embodiments where a solvent is used for material removal, the solvent may dissolve only the excess material remaining on the object 120 (e.g., residual parts of the remaining portions 116) with little or no dissolution of the object 120 itself. The object 120 may be exposed to the solvent for a relatively short time, e.g., no more than 1 hour, 30 minutes, 15 minutes, 10 minutes, 5 minutes, 2 minutes, or 1 minute. Shorter exposure times can be used if the material of the object 120 is susceptible to dissolution in the solvent, whereas longer exposure times can be used if the material of the object 120 is resistant to dissolution in the solvent. The solvent can optionally be heated, e.g., to a temperature of at least 30° C., 40° C., 50° C., 60° C., 70° C., 80° C., 90° C., or 100° C. The solvent can be used at a temperature below the boiling point of the solvent. The solvent can be a nontoxic and/or nonflammable solvent. Examples of solvents that may be used include supercritical or subcritical CO₂, alcohol (e.g., methanol, ethanol, propanol, isopropanol), propylene carbonate, glycols, tetrahydrofuran, dichloromethane, dichloroethane, toluene, benzene, water, acetone, acetic acid, ethyl acetate, and ester derivatives. Additionally, solvents that are considered safe for humans can be used, such as polyethylene glycols, various flavors or fragrances (e.g., mint, banana ester, vanillin), and oils (e.g., vitamin E, vitamin D, fish oil, flax seed oil, sunflower oil). Optionally, the solvent can be used in combination with other material removal techniques, such as application of ultrasonic energy (e.g., sonication).

In embodiments where a centrifuge is used for material removal, the centrifuge may be heated, e.g., to a temperature greater than or equal to the melting point of the excess material. The object 120 may be sprayed with solvent while in the centrifuge to help remove solvated material and/or to prevent the object 120 from sitting in a large volume of solvent for an excess time period.

As another example, energy may be applied to the object 120 during post-processing, e.g., to post-cure the object 120, anneal the object 120, and/or enhance interlayer adhesion within the object 120. Post-curing can be performed in situations where the object 120 is still in a partially cured “green” state after fabrication. For example, the energy used to form the object 120 may only partially polymerize the material forming the object 120. Accordingly, the post-curing process may be needed to fully cure (e.g., fully polymerize, fully crystallize, fully fuse) the object 120 to its final, usable state. Post-curing can provide various benefits, such as improving the mechanical properties (e.g., stiffness, strength) and/or temperature stability of the object 120. Post-curing, annealing, and/or other energy application processes can be performed by heating the object 120, applying electromagnetic energy (e.g., UV, visible, microwave) to the object 120, exposing to ionizing radiation, or suitable combinations thereof.

In a further example, surface modifications can be performed to smooth some or all of the surfaces of the object 120. For example, the object 120 can be exposed to solvent vapor and/or heated to cause any excess material that is present on the object 120 to flow and level, thereby decreasing sharp angles, roughness, irregularities, etc. Moreover, in embodiments where the cuts 118 in the object 120 extend into previous object layers, flowing and leveling of excess material can partially or fully fill in the cuts 118 to provide a smoother finish.

Alternatively or in combination, a coating can be applied to the object 120 for surface modification. The coating can be used to provide desired surface properties, such as smoothness, stain resistance, scratch resistance, water resistance, oil resistance, gloss, matte, color, smell, controlled release, durability, etc. The coating may be applied before removal of excess material or after removal of excess material, and/or before application of energy or after application of energy. Various types of coating materials can be used, such as urethane, epoxy, latex, lacquer, varnish, silane, siloxane, ceramic, and/or other coatings, including reactive coatings that optionally adhere or bond to the object 120. For example, the coating can be a liquid material, such as a liquid that is curable via heat, light, air, humidity, etc. The liquid material may or may not include a solvent. The liquid material can be applied to the object 120 by dipping, spraying, vapor deposition, and/or other suitable liquid deposition techniques. Excess liquid material may be removed via centrifugation, shaking, pressurized air, and/or other suitable removal techniques. The coating can be applied by a vapor deposition such as various metal, metal oxide coatings or perylene. If the part is conductive, then powder coatings can be used.

The system 100 and additive manufacturing process of FIGS. 1A-1G can be modified in many ways. For example, the illustrated embodiment shows a “top down” configuration in which the energy source 108 is positioned above and directs energy down toward the build platform 102, such that the object 120 is formed on the upper surface of the build platform 102. In other embodiments, however, the additive manufacturing process can instead be performed using a “bottom up” configuration in which the energy source 108 is positioned below and directs the energy up toward the build platform 102, such that the object 120 is formed on the lower surface of the build platform 102. Moreover, although FIGS. 1A-1G depict a single object 120, the system 100 and additive manufacturing process can be used to concurrently fabricate any number of objects on the build platform 102. Furthermore, although FIGS. 1A-1G depict a single energy source 108 and a single cutting mechanism 110, the system 100 can alternatively include a plurality of energy sources 108 and/or a plurality of cutting mechanisms 110.

Moreover, in some embodiments, the operation of the system 100 may be “inverted,” e.g., some or all of the material layers 104 may be provided in a crosslinked, melt-resistant, and/or solvent-resistant state, and the energy exposure causes the target portion 114 to become less crosslinked, less melt resistance, and/or less solvent resistant. In such embodiments, the unexposed remaining portion 116 is designated to be part of the printed object (e.g., similar to a negative resist), rather than the target portion 114. Examples of materials suitable for use in the “inverted” process include high molecular weight cyclic poly(phthaldehyde), other similar low ceiling temperature polymers that are stable until heated and/or triggered, and/or other polymers that have a controlled degradation mechanism. In some embodiments, a photoacid generator is used as the trigger and causes immediate reversion of the polymer to monomer (which can be recovered and reused to make new polymer), thus allowing the printed object to be cleaned via a quick water or solvent rinse. In embodiments where the monomer is volatile at room temperature, the rinse may be omitted.

FIGS. 2A-10C illustrate additional features that may be used in the additive manufacturing systems and processes described herein. Any of the embodiments described with respect to FIGS. 2A-10C may be combined with each other and/or incorporated into the system 100 and additive manufacturing process of FIGS. 1A-1G.

As described herein, a cut can be formed in a material layer to facilitate separation of the printed object from excess material. The cut can be positioned at or near a boundary between a target portion of the material layer (e.g., the portion that is cured, polymerized, sintered, melted, fused, adhered, etc., to form an object layer) and one or more remaining portions of the material layer (e.g., the portion(s) that are not cured, polymerized, sintered, melted, fused, adhered, etc.). The positioning of the cut relative to the boundary can be varied as desired, and may be different for different material layers.

For example, referring again to FIG. 1B, the cut 118 may be positioned on the boundary between the target portion 114 and the remaining portions 116 of a material layer. In such embodiments, the material enclosed by the cut 118 can include the target portion 114 only, while the material outside of the cut 118 can include the remaining portions 116 only. This approach can be used, for example, when the resolution and accuracy of the cutting mechanism is sufficiently high.

In some embodiments, a cut in a material layer may be offset from the boundary between the target portion and the remaining portions of the material layer. For example, FIG. 2A is a partially schematic cross-sectional view of a material layer 204a in which the cut 118 is inwardly offset from the boundary between the target portion 114 and the remaining portions 116 of the material layer 204a, e.g., by an offset distance D₁. The offset distance D₁ can be less than or equal to 5×, 4×, 3×, 2×, 1×, 0.5×, 0.25×, 0.1×, or 0.05× of the thickness of the material layer 204a, for example. In some embodiments, the offset distance D₁ is no more than 50 μm, 40 μm, 30 μm, 20 μm, 15 μm, 10 μm, or 5 μm. Due to the offset, the material enclosed by the cut 118 includes the target portion 114 only, whereas the material outside of the cut 118 includes the remaining portions 116 as well as a some of the target portion 114. Stated differently, the cut 118 can be formed in the target portion 114 so that some of the target portion 114 is separated from the rest of the target portion 114 by the cut 118, and thus is removed from the printed object together with the remaining portions 116. This approach may be used, for example, in embodiments where it is desirable to reduce, minimize, or eliminate the uncured or excess material left on the object.

Alternatively, FIG. 2B is a partially schematic cross-sectional view of a material layer 204b in which the cut 118 is outwardly offset from the boundary between the target portion 114 and the remaining portions 116 of the material layer 204a, e.g., by an offset distance D₂. The offset distance D₂ can be less than or equal to 5×, 4×, 3×, 2×, 1×, 0.5×, 0.25×, 0.1×, or 0.05× of the thickness of the material layer 204b, for example. In some embodiments, the offset distance D₂ is no more than 50 μm, 40 μm, 30 μm, 20 μm, 15 μm, 10 μm, or 5 μm. Due to the offset, the material enclosed by the cut 118 includes the target portion 114 as well as some of the remaining portions 116, whereas the material outside of the cut 118 includes the target portion 114 only. Stated differently, the cut 118 can be formed in the remaining portions 116 so that some of the remaining portions 116 are separated from the rest of the remaining portions 116 by the cut 118, and thus remain part of the printed object together with the target portion 114. This approach may be used, for example, in embodiments where it is desirable to avoid cutting into the target portion 114. Moreover, in embodiments where the remaining portions 116 include uncured material, the uncured material can subsequently be treated to cause flowing and leveling to provide a smooth surface finish, e.g., as described below in connection with FIGS. 3A-3C. Cutting into uncured material can also facilitate the removal of large portions of uncured material that might otherwise prevent the removal of an object from the uncured material. For example, a spherical object that is completely surrounded on all sides with strongly adherent uncured material may be trapped even though it is separated from the uncured material via cuts. Cuts radiating away from the boundary on each material layer (and optionally overlapping with similar cuts on subsequent material layers) may be used to break up the continuous mass of the uncured material to allow for facile removal of the embedded object.

FIGS. 3A-3C are partially schematic illustrations of a process for modifying a surface of an object 300, in accordance with embodiments of the present technology. The object 300 can be fabricated from a plurality of material layers deposited on a build platform 302 according to the additive manufacturing process of FIGS. 1A-1G. After additive manufacturing and removal of excess material, the bulk of the object 300 can be composed of cured material 304 (e.g., corresponding to the target portions of the material layers that were cured during additive manufacturing). A thin layer of uncured material 306 may be present on the surfaces of the object 300 (e.g., corresponding to the remaining portions of the material layers that were not cured during additive manufacturing). The uncured material 306 may be present, for example, if the cuts formed in the material layers were outwardly offset from the boundary between the target portions and the remaining portions of the material layers (e.g., as shown in FIG. 2B).

Referring next to FIG. 3B, the object 300 can be heated to cause flow and leveling of the uncured material 306 (e.g., via placement in an oven or heated centrifuge). Alternatively or in combination, flow and leveling of the uncured material 306 can be produced by exposing the object 300 to a solvent (e.g., via solvent washing or vapor polishing). As shown in FIG. 3B, the flow and leveling of the uncured material 306 can result in a smoother external surface of the object 300. For instance, the uncured material 306 can fill in cut lines, smooth out surface irregularities, reduced sharpened edges, etc., thereby producing a smoother surface finish.

Referring next to FIG. 3C, after flow and leveling of the uncured material 306, the object 300 can be post-cured (e.g., via heat and/or light) to cure the uncured material 306. Accordingly, the post-cured object 300 can be composed entirely of the cured material 304 with a smooth external surface.

In some embodiments, the additive manufacturing processes described herein are used to fabricate objects with complex geometries, such as overhangs and/or islands, without requiring sacrificial support structures that are printed together with the object and removed during post-processing. Instead, the previously deposited material layers remain in place throughout the additive manufacturing process and thus can provide support for overhangs and/or islands in subsequently deposited material layers. Moreover, the material layers can be treated and/or modified to reduce interlayer adhesion at the overhangs and/or islands, thereby allowing those portions of the object to be cleanly and easily separated from excess material (e.g., the underlying material layers) after the additive manufacturing process is complete.

FIG. 4 is a partially schematic cross-sectional view of an object 400 including an overhang, in accordance with embodiments of the present technology. The object 400 can include a plurality of object layers (e.g., a first object layer 402a, a second object layer 402b, and a third object layer 402c—collectively, “object layers 402”) that are sequentially formed according to the additive manufacturing process of FIGS. 1A-1G. In the illustrated embodiment, for example, the object 400 is fabricated from a first material layer 404a, a second material layer 404b, and a third material layer 404c (collectively, material layers 404) that are sequentially deposited on a build platform 406. Each material layer 404 can include a target portion 408 that is cured, polymerized, sintered, melted, fused, adhered, etc., to form the respective object layer 402; at least one remaining portion 410 that is not cured, polymerized, sintered, melted, fused, adhered, etc.; and at least one cut 412 at or near the boundary between the target portion 408 and the remaining portion 410.

In the illustrated embodiment, the third object layer 402c includes at least one overhang 414 that extends laterally beyond the second object layer 402b. The overhang 414 can be supported by at least a portion of the second material layer 404b, such as by the remaining portion 410 of the second material layer 404b. To facilitate a clean separation between the overhang 414 and the remaining portion 410 of the second material layer 404b after the additive manufacturing process is completed, the overhang 414 can be formed with a lower degree of curing at or near the interface with the second material layer 404b, and a higher degree of curing away from the interface with the second material layer 404b. The different degrees of curing can be achieved, for example, by using a lower energy intensity and/or exposure time to form the overhang 414 so that the lower part of the overhang 414 is only partially cured or remains substantially uncured, thereby producing reduced interlayer adhesion to the remaining portion 410 of the second material layer 404b. The energy intensity and/or exposure time for the parts of the third object layer 402c that are away from the overhang 414 (e.g., central portion 416) can be higher so that these parts are mostly or fully cured, thereby producing higher interlayer adhesion to the underlying second object layer 402b.

FIGS. 5A and 5B are partially schematic cross-sectional views of a process for forming an object 500 with an overhang, in accordance with embodiments of the present technology. The object 500 can include a plurality of object layers (e.g., a first object layer 502a, a second object layer 502b, and a third object layer 502c—collectively, “object layers 502”) that are sequentially formed according to the additive manufacturing process of FIGS. 1A-1G. In the illustrated embodiment, for example, the object 500 is fabricated from a first material layer 504a, a second material layer 504b, and a third material layer 504c (collectively, material layers 504) that are sequentially deposited on a build platform 506. Each material layer 504 can include a target portion 508 that is cured, polymerized, sintered, melted, fused, adhered, etc., to form the respective object layer 502; at least one remaining portion 510 that is not cured, polymerized, sintered, melted, fused, adhered, etc.; and at least one cut 512 at or near the boundary between the target portion 508 and the remaining portion 510.

Referring to FIG. 5B, in the illustrated embodiment, the third object layer 502c includes at least one overhang 514 that extends laterally beyond the second object layer 502b. The overhang 514 can be supported by at least a portion of the second material layer 504b, such as by the remaining portion 510 of the second material layer 504b. To facilitate a clean separation between the overhang 514 and the remaining portion 510 of the second material layer 504b after the additive manufacturing process is completed, an adhesion inhibitor 516 can be positioned between the overhang 514 and the remaining portion 510 of the second material layer 504b. The adhesion inhibitor 516 can be any material that reduces or prevents the material of the overhang 514 from adhering to the material of the remaining portion 510. For example, the adhesion inhibitor 516 can be a cure inhibitor, which may depend on the type of curing that is being used (e.g., a radical inhibitor, a cationic inhibitor, an anionic inhibitor, or other inhibitor). As another example, the adhesion inhibitor 516 may be a liquid or solid that prevents direct contact between the overhang 514 and the remaining portion 510. The liquid or solid may be a material that does not interact with the remaining portion 510, the overhang 514, and/or with itself. Examples of solids that may be used as the adhesion inhibitor 516 include talc, carbon black, finely ground polymer, thin polymer sheets, wax, silica, glass flakes, mica, electrospun fibers, cured in place inkjet ink, etc. Examples of liquids that may be used as the adhesion inhibitor 516 include silicon oil, volatile cyclic silicones, water, oil, liquid wax, etc. In some embodiments, the adhesion inhibitor 516 is a material that can be removed from the remaining portion 510 during processing of the unused remaining portion 510 for reuse. For example, water boils at 100° C. and thus can be removed from the remaining portion 510 when heated and/or placed in a vacuum. Liquids and solids likewise may be removed from the remaining portion 510 by washing in solvent, filtering, or other removal mechanism. Alternatively, the locations of the remaining portion 510 including the adhesion inhibitor 516 can be cut and separated from other locations of the remaining portion 510 to prevent contamination during processing for reuse.

As shown in FIG. 5A, the adhesion inhibitor 516 can be applied to the second material layer 504b before the third material layer 504c is deposited. Specifically, the adhesion inhibitor 516 can be localized only to the parts of the second material layer 504b that will be adjacent or proximate to the overhang 514, e.g., to the parts of the remaining portion 510 of the second material layer 504b that will be underneath the overhang 514. The adhesion inhibitor 516 can be deposited from one or more applicators (e.g., nozzles, sprayers, extruders, ink jets) using any suitable material deposition technique, such as ink jetting, spraying, extruding, pulsed liquid deposition (e.g., PICO Pμlse), powder deposition, toner powder deposition, etc. Subsequently, as shown in FIG. 5B, the third material layer 504c can be deposited onto the second material layer 504b and the adhesion inhibitor 516, and the third object layer 502c can be formed from the third material layer 504c. The presence of the adhesion inhibitor 516 can prevent the overhang 514 from adhering to the underlying parts of the second material layer 504b, e.g., even if some overcuring into the second material layer 504b occurs. Alternatively, for embodiments that use an adhesion promotor to adhere the material layers 504, a lack of adhesion promotor at the parts of the second material layer 504b that will be adjacent or proximate to the overhang 514 may produce a similar non-adhering effect.

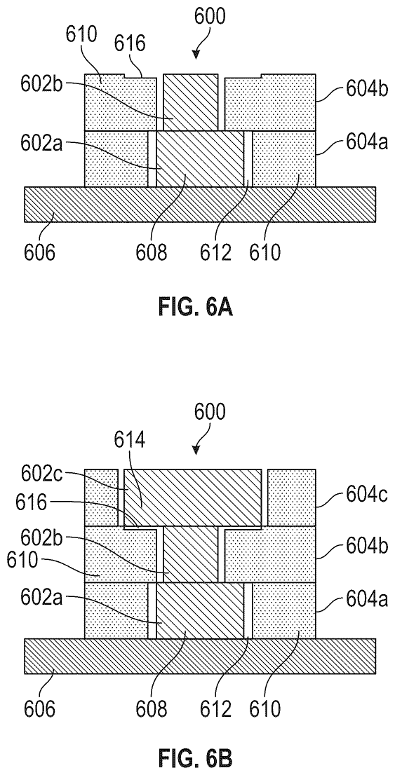

FIGS. 6A and 6B are partially schematic cross-sectional views of another process for forming an object 600 with an overhang, in accordance with embodiments of the present technology. The object 600 can include a plurality of object layers (e.g., a first object layer 602a, a second object layer 602b, and a third object layer 602c—collectively, “object layers 602”) that are sequentially formed according to the additive manufacturing process of FIGS. 1A-1G. In the illustrated embodiment, for example, the object 600 is fabricated from a first material layer 604a, a second material layer 604b, and a third material layer 604c (collectively, material layers 604) that are sequentially deposited on a build platform 606. Each material layer 604 can include a target portion 608 that is cured, polymerized, sintered, melted, fused, adhered, etc., to form the respective object layer 602; at least one remaining portion 610 that is not cured, polymerized, sintered, melted, fused, adhered, etc.; and at least one cut 612 at or near the boundary between the target portion 608 and the remaining portion 610.

Referring to FIG. 6B, in the illustrated embodiment, the third object layer 602c includes at least one overhang 614 that extends laterally beyond the second object layer 602b. The overhang 614 can be supported by at least a portion of the second material layer 604b, such as by the remaining portion 610 of the second material layer 604b. To facilitate a clean separation between the overhang 614 and the remaining portion 610 of the second material layer 604b after the additive manufacturing process is completed, a gap 616 can be formed between the overhang 614 and the remaining portion 610 of the second material layer 604b, thereby preventing the overhang 614 from adhering to the remaining portion 610 of the second material layer 604b.

As shown in FIG. 6A, the gap 616 can be formed in the second material layer 604b before the third material layer 604c is deposited. Specifically, material can be selectively removed from the parts of the second material layer 604b that will be adjacent or proximate to the overhang 614, e.g., to the parts of the remaining portion 610 of the second material layer 604b that will be underneath the overhang 614. The material may be removed by a cutting mechanism, such as a laser cutter, a blade, a blasting device, a milling device, a waterjet cutter, etc. The cutting mechanism may be the same cutting mechanism used to form the cuts 612, or may be a different cutting mechanism. Subsequently, as shown in FIG. 6B, the third material layer 604c can be deposited onto the second material layer 604b, and the third object layer 602c can be formed from the third material layer 604c. The presence of the gap 616 can prevent the overhang 614 from adhering to the underlying parts of the second material layer 604b, e.g., even if some overcuring into the second material layer 604b occurs.

Although some embodiments of the additive manufacturing systems and processes herein use cutting mechanisms that are positioned above the material layers, the present technology may alternatively or additionally include cutting mechanisms that are positioned at a different location relative to the material layers, such as at a lateral side of the material layers or below the material layers. Moreover, the cutting mechanisms described herein may be used to form one or more cuts in a material layer at any point during the additive manufacturing process, including during the printing of the material layer (e.g., while energy is being applied to the material layer), after the printing of the material layer (e.g., after one or more subsequent material layers have been deposited onto the material layer), or suitable combinations thereof. Additionally, although some embodiments of the additive manufacturing systems and processes described herein use vertically oriented cutting mechanisms that form vertical cuts in the material layers, the present technology may alternatively or additionally include cutting mechanisms that are angled and/or form angled cuts in the material layers.

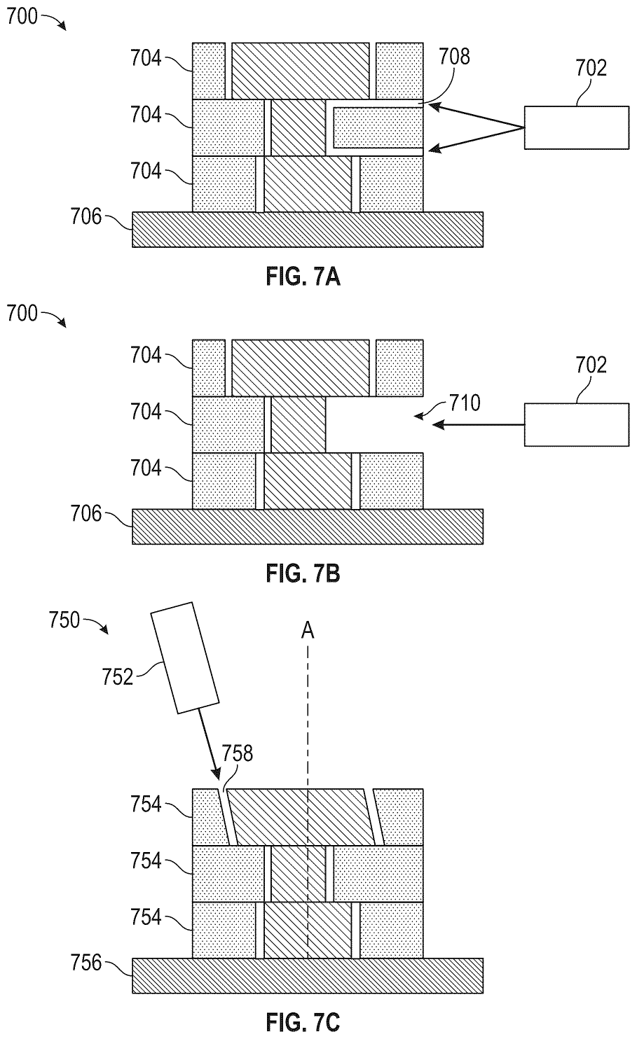

For example, FIG. 7A is a partially schematic cross-sectional view of a system 700 including a laterally-positioned cutting mechanism 702, in accordance with embodiments of the present technology. The cutting mechanism 702 can be generally similar to the cutting mechanism 110, except that the cutting mechanism 702 is located at a lateral side of the material layers 704 (and, optionally, to a lateral side of the build platform 706 supporting the material layers 704). For example, the cutting mechanism 702 can be a laser cutter, a blade, a blasting device, a milling device, or a waterjet cutter.

The cutting mechanism 702 can be used to form one or more cuts 708 in a lateral portion of a material layer 704. In the illustrated embodiment, the cuts 708 extend from a lateral surface of the material layer 704 toward the interior of the material layer 704. Although the cuts 708 are each depicted as being horizontal, in other embodiments, some or all of the cuts 708 can be angled. The cuts 708 can be formed in a portion of the material layer 704 that is not cured, polymerized, sintered, melted, fused, adhered, etc., during the additive manufacturing process, e.g., to facilitate separation of excess material from the printed object. For example, in the illustrated embodiment, the cuts 708 can be used to prevent overhangs from adhering to the underlying material layer 704, e.g., similar to the gap 616 of FIGS. 6A and 6B.

Optionally, as shown in FIG. 7B, the cutting mechanism 702 can be used to completely remove a portion of a material layer 704, thereby leaving a cavity 710 in the material layer 704. By forming the cavity 710, the amount of excess material to be removed after additive manufacturing can be reduced. Moreover, the cavity 710 can be used to prevent overhangs from adhering to the underlying material layer 704, e.g., similar to the gap 616 of FIGS. 6A and 6B.

FIG. 7C is a partially schematic cross-sectional view of a system 750 including an angled cutting mechanism 752, in accordance with embodiments of the present technology. The cutting mechanism 752 can be generally similar to the cutting mechanism 110, except that the cutting mechanism 752 is angled relative to the vertical axis A of the material layers 754 and build platform 756. The cutting mechanism 752 can be a laser cutter, a blade, a blasting device, a milling device, or a waterjet cutter.

As shown in FIG. 7C, the cutting mechanism 752 can be used to form one or more angled cuts 758 in a material layer 754, e.g., to better conform to the local angle of the object surface. For example, any of the angled cuts 758 in a material layer 754 can be at an angle relative to the vertical axis A that is greater than or equal to 5°, 10°, 20°, 30°, 40°, 45°, 50°, 60°, 70°, 80°, 90°, 100°, 110°, 120°, 130°, 140°, 150°, 160°, 170°, or 180°. In some embodiments, the cutting mechanism 752 is rotatable to a plurality of different angles relative to the vertical axis A to allow for cutting at different angles. Alternatively, the cutting mechanism may remain in a single fixed orientation, but the output of the cutting mechanism 752 (e.g., the laser beam) may be rotatable to a plurality of different angles. In some embodiments, the cutting extends into and/or through more than one material layer 754.

In some embodiments, a cutting mechanism of the present technology may alternatively or additionally be used to form one or more cuts (e.g., grooves, recesses, holes, channels, slits) in a portion of the object, such as in one or more object layers that have been cured, polymerized, sintered, melted, fused, adhered, etc., by application of energy to a material layer as described herein. A cut may be formed in an object layer at any point during the additive manufacturing process, such as before one or more subsequent object layers have been formed on the object layer, after one or more subsequent object layers have been deposited onto the object layer, or suitable combinations thereof. The cut can be used to produce a desired object geometry (e.g., generate surface features for assembling the object to another object), modify the object surface (e.g., reduce surface roughness), etc.

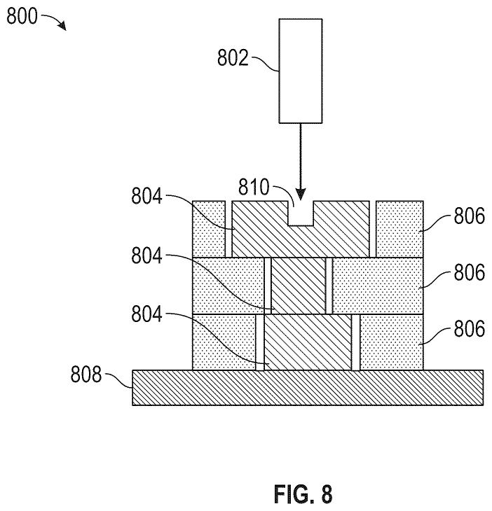

FIG. 8 is a partially schematic cross-sectional view of a system 800 including a cutting mechanism 802 for forming a cut in an object, in accordance with embodiments of the present technology. The cutting mechanism 802 can be generally similar to the other cutting mechanisms described herein, such as the cutting mechanism 110 of FIGS. 1A-1G, the cutting mechanism 702 of FIGS. 7A and 7B, and/or the cutting mechanism 752 of FIG. 7C. For example, the cutting mechanism 802 can be a laser cutter, a blade, a blasting device, a milling device, or a waterjet cutter. In the illustrated embodiment, the object is composed of a plurality of object layers 804 that are formed from a plurality of corresponding material layers 806 on a build platform 808, e.g., according to the additive manufacturing process of FIGS. 1A-1G. The cutting mechanism 802 can be used to form a cut 810 in one or more of the object layers 804. For example, although FIG. 8 depicts the cut 810 as being formed in the uppermost object layer 804, one or more cuts 810 can alternatively or additionally be formed in any other object layer 804 by the cutting mechanism 802.

In some embodiments, the additive manufacturing processes described herein allow for fabrication of object geometries that are difficult or impossible to produce using conventional techniques. For example, the additive manufacturing processes herein can be used to fabricate objects with cavities that are partially or entirely enclosed within the interior of the object. In such embodiments, the cutting mechanism can be used to partially or fully ablate a portion of one or more material layers to form a cavity, and one or more subsequent material layers can be deposited onto the one or more material layers to enclose the cavity.

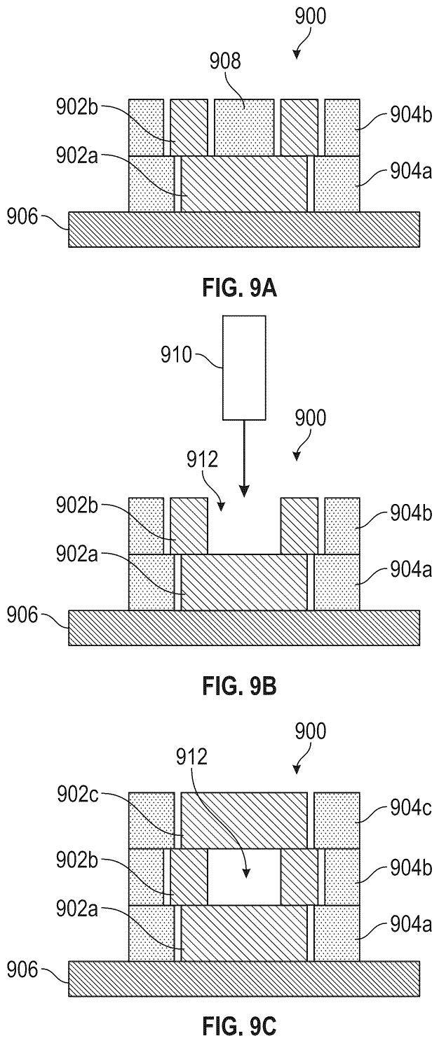

FIGS. 9A-9C are partially schematic cross-sectional views of an additive manufacturing process for forming an object 900 including an internal cavity, in accordance with embodiments of the present technology. Referring first to FIG. 9A, the object 900 can be composed of a plurality of object layers (e.g., a first object layer 902a and a second object layer 902b) that are formed from a corresponding plurality of material layers (e.g., a first material layer 904a and a second material layer 904b) on a build platform 906 according to the additive manufacturing process of FIGS. 1A-1G. In the illustrated embodiment, the second material layer 904b includes an internal portion 908 that is not intended to be part of the final object 900 and thus is not cured, polymerized, sintered, melted, fused, adhered, etc., during the additive manufacturing process.

Referring next to FIG. 9B, a cutting mechanism 910 can be used to ablate the internal portion 908 of the second material layer 904b, thereby creating a cavity 912 in the second material layer 904b. The cutting mechanism 910 can be identically or generally similar to the other cutting mechanisms described herein, such as the cutting mechanism 110 of FIGS. 1A-1G, the cutting mechanism 702 of FIGS. 7A and 7B, the cutting mechanism 752 of FIG. 7C, and/or the cutting mechanism 802 of FIG. 8. For example, the cutting mechanism 910 can be a laser cutter, a blade, a blasting device, a milling device, or a waterjet cutter.

Optionally, other techniques can be used to remove the internal portion 908 of the second material layer 904b, alternatively or in addition to the cutting mechanism 910. For instance, the internal portion 908 can be removed using a robotic arm, vacuum, air gun, or other suitable device. As another example, the build platform 906 can be inverted so that the internal portion 908 falls out due to gravity. In some embodiments, the cutting mechanism 910 cuts the internal portion 908 into smaller pieces that are more easily removed by another device and/or via inversion of the build platform 906.

Referring next to FIG. 9C, a third material layer 904c can be deposited onto the second material layer 904b, and a third object layer 902c can be formed from the third material layer 904c in accordance with the techniques described herein. In the illustrated embodiment, the cavity 912 is completely enclosed by the first object layer 902a, the second object layer 902b, and the third object layer 902c. In other embodiments, the cavity 912 can instead be partially enclosed, e.g., there may be a gap in one or more of the first object layer 902a, the second object layer 902b, and/or the third object layer 902c that connects the cavity 912 to the exterior of the object 900.

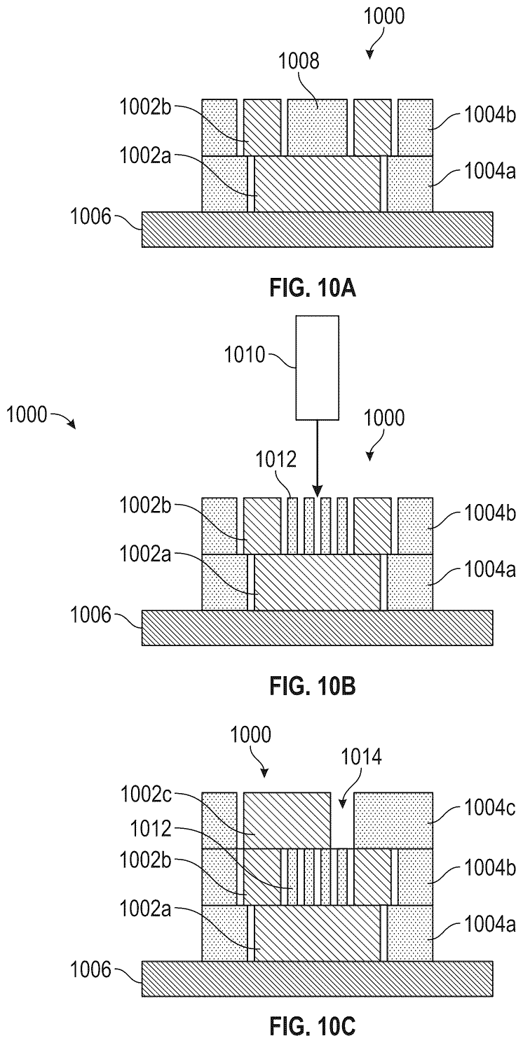

FIGS. 10A-10C are partially schematic cross-sectional views of an additive manufacturing process for forming an object 1000 including an internal cavity, in accordance with embodiments of the present technology. Referring first to FIG. 10A, the object 1000 can be composed of a plurality of object layers (e.g., a first object layer 1002a and a second object layer 1002b) that are formed from a corresponding plurality of material layers (e.g., a first material layer 1004a and a second material layer 1004b) on a build platform 1006 according to the additive manufacturing process of FIGS. 1A-1G. In the illustrated embodiment, the second material layer 1004b includes an internal portion 1008 that is not intended to be part of the final object 1000 and thus is not cured, polymerized, sintered, melted, fused, adhered, etc., during the additive manufacturing process.

Referring next to FIG. 10B, a cutting mechanism 1010 can be used to cut the internal portion 1008 of the second material layer 1004b into a plurality of smaller fragments 1012. The cutting mechanism 1010 can be identically or generally similar to the other cutting mechanisms described herein, such as the cutting mechanism 110 of FIGS. 1A-1G, the cutting mechanism 702 of FIGS. 7A and 7B, the cutting mechanism 752 of FIG. 7C, the cutting mechanism 802 of FIG. 8, and/or the cutting mechanism 910 of FIGS. 9A-9C. For example, the cutting mechanism 1010 can be a laser cutter, a blade, a blasting device, a milling device, or a waterjet cutter.

Referring next to FIG. 10C, a third material layer 1004c can be deposited onto the second material layer 1004b, and a third object layer 1002c can be formed from the third material layer 1004c in accordance with the techniques described herein. The third object layer 1002c can include a gap 1014 that is sufficiently large to allow the fragments 1012 to be removed from the second material layer 1004b, thereby creating a cavity inside the object 1000. The gap 1014 can be formed using the cutting mechanism 1010 or another cutting mechanism. The fragments 1012 may be removed using a robotic arm, vacuum, air gun, or other suitable device, and/or by inverting the build platform 1006 to allow the fragments 1012 to fall out through the gap 1014. Alternatively or in combination, the fragments 1012 may have a larger surface area that allows them to be removed via techniques such as solvent dissolution and/or melting, while avoiding degradation or other damage to the rest of the object 1000. In some embodiments, the portion of the first material layer 1004a that is underneath the fragments 1012 and/or the portion of the third material layer 1004c that is above the fragments 1012 is coated with an adhesion inhibitor to facilitate removal of the fragments 1012, e.g., as previously described in connection with FIGS. 5A and 5B.

The removal of the fragments 1012 may be performed at any suitable time, such as during the additive manufacturing process (e.g., before the object 1000 has been completed printed), after the additive manufacturing process (e.g., during post-processing of the object 1000), or a combination thereof. After the fragments 1012 have been removed, the resulting cavity can be partially enclosed by the first object layer 1002a, the second object layer 1002b, and the third object layer 1002c, and connected to the exterior of the object 1000 via the gap 1014. This approach can be advantageous in situations where the fragments 1012 are helpful for supporting subsequent object layers during additive manufacturing (e.g., in embodiments where the third object layer 1002c might deform or collapse without support), but are not intended to be part of the final object 1000.

The additive manufacturing processes described herein can be implemented using many different types of systems and devices. In some embodiments, for example, a system of the present disclosure can include a carrier film configured to support a material layer, e.g., during fabrication of the material layer and/or during fabrication of an object layer from the material layer. The carrier film may be a loop or roll that facilitates transport and/or handling of the material layer. The carrier film may remain in place during exposure of the material layer to energy (e.g., thermal or light exposure), or may be removed before exposure of the material layer to energy. The carrier film may remain in place during cutting of the material layer, or may be removed before the cutting process. In embodiments where the carrier film remains in place during energy exposure and/or cutting, the carrier film can be partially or fully transparent to the wavelength(s) of energy used for the exposure and/or cutting. In some embodiments, the carrier film is also degraded and/or cut during the cutting process.

In some embodiments, the carrier film is removed during and/or after the additive manufacturing process and is not part of the printed object. In such embodiments, the carrier film may be made out of a low surface energy material to facilitate separation from the material of the object, such as polydimethylsiloxane derivatives or polyfluorinated materials. Additional examples of materials that may be used in the carrier film are provided in U.S. patent application Ser. No. 18/600,201, the disclosure of which is incorporated by reference herein in its entirety. In some embodiments, the carrier film is not removed after additive manufacturing and becomes part of the printed object. In some embodiments, the carrier film serves as a bonding agent to adhere the object layers together, e.g., the carrier film may be made of a photoactive material that reacts with light and/or heat to produce adhesion.

FIGS. 11A-14 illustrate examples of systems and devices that may be used in combination with the additive manufacturing systems and processes described herein. Any of the features of the embodiments of FIGS. 1A-10C can be combined with the embodiments of FIGS. 11A-14. Moreover, any of the features of the embodiments of FIGS. 11A-14 can be combined with each other. Identical reference numbers across FIGS. 11A-14 are used to indicate identical or generally similar components.

FIGS. 11A and 11B are partially schematic illustrations of a system 1100 for additive manufacturing of an object, in accordance with embodiments of the present technology. Referring first to FIG. 11A, the system 1100 includes a printer 1102 that is equipped with a resin injector 1104 that introduces resin 1106 to the printer. In some embodiments, the resin injector introduces the resin 1106 to the printer in a heated state as a hot resin 1108. The printer 1102 includes a carrier film 1110. The resin injector 1104 introduces the resin 1106 to the printer 1102 by application of the material to the carrier film 1110, thereby forming a resin layer in situ. In some embodiments, the printer 1102 includes a heating plate 1112 to heat the introduced resin 1106 to a heated state or to maintain the heated state of the hot resin 1108.

In some embodiments, the printer 1102 includes a layer thickness controller 1114. In some embodiments, the layer thickness controller 1114 is a doctor blade. The layer thickness controller 1114 is a device to control the thickness of the resin 1106 or hot resin 1108 on the carrier film 1110. Optionally, in some embodiments, the layer thickness controller 1114 can be used to block resin deposition for sections of the carrier film 1110.

In some embodiments, the printer 1102 includes a device 1116 configured to apply an additional component to the resin, such as a solid particulate or a liquid spray. In some embodiments the device 1116 is configured to apply an adhesion promoter 1118. In some embodiments, the device 1116 is a hopper or a sprayer. In some embodiments, the adhesion promoter 1118 promotes the adhesion of resin layers in the printed object 1130. In some embodiments, the adhesion promoter is a liquid adhesion promotor. In some embodiments, the adhesion promoter is a powdered adhesion promoter. For example, the adhesion promoter 1118 can be an infrared absorbing compound, such that infrared energy is absorbed by the infrared absorbing compound and heats the surrounding area (e.g., the surface of the hot resin 1108). Examples of infrared absorbing compounds include carbon black, non-black dyes that absorb infrared energy, multi-photon absorbers, metal particles or nanoparticles, and water absorbed into silica (in which case microwave energy can be applied to induce heat in the layer to melt the layer together, during or after printing). Other types of adhesion promoters 1118 that may be used include adhesives or other monomer systems that are capable of bonding two layers together during the print exposure. In some embodiments, the adhesion promoter 1118 is spread onto the surface of the hot resin 1108. In some embodiments, the adhesion promoter 1118 and/or other additive is added to the resin while the resin is at least partially cooled. In some embodiments, the adhesion promoter 1118 and/or other additive is added to the resin while the resin is fully cooled.

The carrier film 1110 transports the resin materials through the printer 1102, e.g., along the direction indicated by arrow 1120. The hot resin 1108 is transported proximate to a cooling plate 1122 which is configured to cool the temperature of the hot resin 1108 to a cold resin 1124. The cold resin 1124 can be in a solid or semi-solid state. In some embodiments, the cooling plate 1122 is connected to a chiller, a thermoelectric cooler, or another cooling mechanism (e.g., air cooling, evaporative cooling, CO₂ snow jet).

The cold resin 1124 is transported to a build platform 1126. The cold resin 1124 is deposited onto the build platform 1126 as a solid or semi-solid sheet and is exposed to light from a light source 1128, curing the cold resin 1124. Layers of the cold resin 1124 are successively deposited and cured through exposure to light from the light source 1128. In this manner, a printed object 1130 is formed from a plurality of resin layers, with each resin layer including a cured portion 1132 (e.g., cured resin) corresponding to a respective layer of the printed object 1130, and an uncured portion 1134 (e.g., uncured resin) that is not intended to become part of the printed object 1130. The uncured portions 1134 can remain in place together with the cured portions 1132 throughout the additive manufacturing process. The uncured portions 1134 can act to support the printed object 1130, such that support structures for the printed object 1130 are not needed.

The printer 1102 also includes means for moving the build platform relative to the unit including the carrier film, such as a motor or other actuator (not shown). In some embodiments, the movement is horizontal, or otherwise substantially similar to the movement of the proximal carrier film 1110, e.g., as indicated by arrow 1136. In some embodiments, the movement of the build platform 1126 matches the rate of movement of the carrier film 1110 such that each layer of cold resin 1124 is sequentially deposited onto the build platform 1126 and/or the printed object 1130.

In some embodiments, the printer 1102 also includes an infrared heater 1138 configured to warm the surface of the cold resin 1124. Warming the surface of the cold resin 1124 in some embodiments promotes layer-to-layer adhesion as the printed object 1130 is built. For example, as shown in FIG. 11A, the infrared heater 1138 is illustrated as being located at the bottom of the cold resin 1124 (e.g., configured to heat the surface of the cold resin that will be in contact with the build platform 1126 or printed object 1130). Alternatively or in combination, a heating plate 1140 can be placed in contact with the carrier film 1110 to heat the cold resin 1124 through the carrier film 1110. In some embodiments, the printer 1102 includes an infrared heater configured to irradiate and heat the top of the printed object 1130 to which the cold resin 1124 is applied (e.g., the infrared heater can be located above the printed object 1130).

The system 100 further includes a cutting mechanism 1142, such as a laser cutter, a blade, a blasting device, a milling device, or a waterjet cutter. The cutting mechanism 1142 can be coupled to the printer 1102, e.g., the cutting mechanism 1142 can be attached to the same carriage that also includes the components of the printer 1102 (e.g., the light source 1128, heating plate 1112, cooling plate 1122, etc.). Alternatively, the cutting mechanism 1142 can be separate from the printer 1102, such as a standalone unit that travels on the same track as the printer 1102 or at least in the same direction. Although the cutting mechanism 1142 is depicted as being positioned to a lateral side of the printer 1102, in other embodiments, the cutting mechanism 1142 can be positioned differently. For instance, the cutting mechanism 1142 can be mounted above the build platform 1126 and printer 1102 so that the printer 1102 can pass underneath the cutting mechanism 1142.

Referring next to FIG. 11B, after each resin layer is deposited and cured, the cutting mechanism 1142 is used to form one or more cuts 1144 in the resin layer at or near the boundary between the cured portion 1132 and the uncured portion 1134 of the resin layer. In some embodiments, the build platform 1126 is moved laterally away from the printer 1102 to allow the cutting mechanism 1142 to access the resin layer. Alternatively, the build platform 1126 can remain stationary while the printer 1102 moves laterally. Once a resin layer has been printed and cut as appropriate, the build platform 1126 can be moved vertically relative to the printer 1102 to provide room for the next resin layer.

The process of depositing a resin layer, curing the resin layer with the light source 1128, and forming cuts in the resin layer with the cutting mechanism 1142 can be repeated until the entire printed object 1130 is formed. The printed object 1130 can then be separated from the uncured portions 1134 along the cuts 1144 in the resin layers. The uncured portions 1134 can be recycled. As a non-limiting example, the uncured portions 1134 can be removed from the 3D printed object 1130 upon completion of the building of the printed object 1130, and can be re-heated and deposited into the printer 1102 via the resin injector 1104. In some embodiments, the printer 1102 includes a re-melter 1146 that can be activated if needed (e.g., to remove or heat residual uncured resin attached to the carrier film 1110).

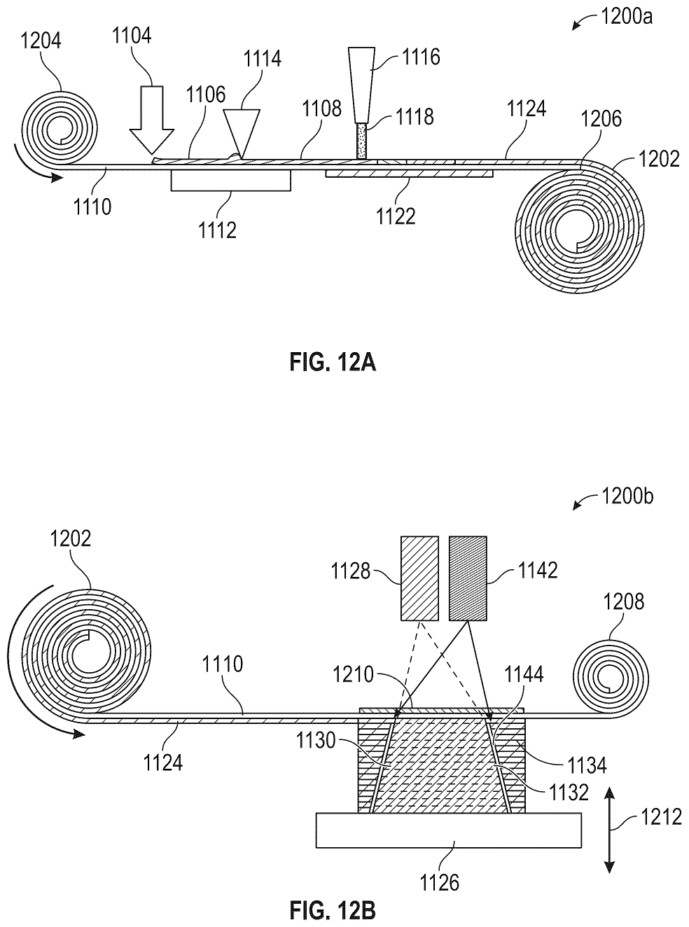

FIGS. 12A and 12B are partially schematic illustrations of processes for additive manufacturing of an object, in accordance with embodiments of the present technology. Specifically, FIG. 12A illustrates a first process phase 1200a in which a continuous roll of material for additive manufacturing of the object is fabricated, and FIG. 12B illustrates a second process phase 1200b in which the object is formed from the prefabricated continuous roll of material. A solid block of material (e.g., a plurality of resin layers including cured portions 1132 and uncured portions 1134) is built as the 3D printed object 1130 is constructed. In some embodiments, a roll 1202 of uncured cold resin 1124 and carrier film 1110 is formed in the first process phase 1200a, and is then used in the second process phase 1200b during the formation of the 3D printed object 1130. The first process phase 1200a and second process phase 1200b can be separated by distance (e.g., each process can take place in separate locations or facilities) and/or can be separated in time (e.g., the roll 1202 can be formed in advance of its use in the second process phase 1200b). In this manner, the solid resin (e.g., on roll 1202) can be transportable (e.g., shipped to a manufacturing location) or stored until ready for use. In some embodiments, the first process phase 1200a feeds directly into the second process phase 1200b, skipping the formation of the roll 1202.

The first process phase 1200a adheres uncured resin to a carrier film 1110 and the second process phase 1200b manufactures the 3D printed object 1130. The carrier film 1110 to convey the resin materials. The carrier film 1110 is supplied by a carrier film feed roll 1204. The first process phase 1200a includes a resin injector 1104 that introduces resin 1106 to the carrier film 1110. In some embodiments, the resin injector 1104 introduces the resin 1106 to the carrier film 1110 in a heated state as a hot resin 1108. In some embodiments, the first process phase 1200a includes a heating plate 1112 to heat the introduced resin 1106 to a heated state and/or to maintain the heated state of the hot resin 1108.

In some embodiments, the first process phase 1200a includes a layer thickness controller 1114. In some embodiments, the layer thickness controller 1114 is a doctor blade. The layer thickness controller 1114 is a device to control the thickness of the resin 1106 or hot resin 1108 on the carrier film 1110. In some embodiments, the hot resin 1108 is transported proximate to a cooling plate 1122 which is configured to cool the temperature of the hot resin 1108 to a cold resin 1124 (e.g., a solid or semi-solid resin). In some embodiments, the cooling plate 1122 is connected to a chiller, a thermoelectric cooler, or another cooling mechanism. In some embodiments, the hot resin 1108 is transported proximate to an air fan, a water bath, or another cooling mechanism configured to cool the temperature of the hot resin 1108 to a cold resin 1124. The cold resin 1124 is taken up by a take-up reel 1206, thereby forming a continuous roll 1202 of uncured cold resin 1124 and carrier film 1110.

Some embodiments of the first process phase 1200a include a device 1116 configured to apply an adhesion promoter 1118. In some embodiments, the device 1116 configured to apply the adhesion promoter 1118 is a hopper or a sprayer. In some embodiments, the adhesion promoter 1118 promotes the adhesion of resin layers in the printed object 1130. In some embodiments, the adhesion promoter is a liquid adhesion promotor. In some embodiments, the adhesion promoter 1118 is a powdered adhesion promoter. In some embodiments, the device 1116 configured to apply the adhesion promoter 1118 is also configured to apply a material to prevent two layers of the cold resin 1124 from sticking together on the roll 1202. In some embodiments, the adhesion promoter 1118 prevents the cold resin 1124 from sticking together on the roll 1202. The adhesion promoter 1118 can be spread onto the surface of the hot resin 1108 or cold resin 1124.

In the second process phase 1200b, the roll 1202 of uncured cold resin 1124 and carrier film 1110 is unrolled, and the carrier film 1110 transports the resin toward a take-up reel 1208. The cold resin 1124 is transported to a build platform 1126. The cold resin 1124 is deposited onto the build platform 1126 and is exposed to light from a light source 1128, curing the resin. Optionally, the second process phase 1200b includes a window 1210 between the light source 1128 and the carrier film 1110. Layers of the cold resin 1124 are successively deposited and cured through exposure to light from the light source 1128. In this manner, a printed object 1130 is formed from a plurality of resin layers, with each resin layer including a cured portion 1132 corresponding to a respective layer of the printed object 1130, and an uncured portion 1134 that is not intended to become part of the printed object 1130. The uncured portions 1134 can remain in place together with the cured portions 1132 throughout the additive manufacturing process. The uncured portions 1134 can act to support the printed object 1130, such that support structures for the printed object 1130 are not needed.

The second process phase 1200b also includes means for moving the build platform 1126 relative to the unit including the carrier film 1110, such as a motor or other actuator (not shown). In some embodiments, the movement is vertical, or otherwise substantially perpendicular to the movement of the proximal carrier film 1110, e.g., as indicated by arrow 1212. In some embodiments, the movement is of the build platform 1126. In some embodiments, the movement is of the unit including the carrier film 1110.

In the second process phase 1200b, after each resin layer is deposited and cured, a cutting mechanism 1142 (e.g., a laser cutter, a blade, a blasting device, a milling device, or a waterjet cutter) is used to form one or more cuts 1144 in the resin layer at or near the boundary between the cured portion 1132 and the uncured portion 1134 of the resin layer. In some embodiments, the build platform 1126 is moved laterally away from the carrier film 1110 to allow the cutting mechanism 1142 to access the resin layer. Alternatively, the build platform 1126 can remain stationary while the carrier film 1110 is moved laterally away from the build platform 1126. Optionally, in embodiments where the cutting mechanism 1142 is a laser cutter, the laser energy can pass through the window 1210 (if present) and the carrier film 1110 to access the resin layer, such that the build platform 1126 and carrier film 1110 need not be moved laterally during the cutting process. In such embodiments, the material of the window 1210 and carrier film 1110 can be selected to be partially or entirely transparent to the wavelength of the laser energy. In such embodiments, the laser cutting can occur after vertical separation of carrier film 1110 and the top layer of the printed object 1130 to provide space for ablative gases that may be formed.

The process of depositing a resin layer, curing the resin layer with the light source 1128, and forming cuts in the resin layer with the cutting mechanism 1142 can be repeated until the entire printed object 1130 is formed. The printed object 1130 can then be separated from the uncured portions 1134 along the cuts 1144 in the resin layers. The uncured portions 1134 can be recycled. As a non-limiting example, the uncured portions 1134 can be removed from the 3D printed object 1130 upon completion of the building of the printed object 1130, and can be re-heated and deposited into the first process phase 1200a via the resin injector 1104. In some embodiments, the take-up reel 1208 includes unused cold resin 1124.

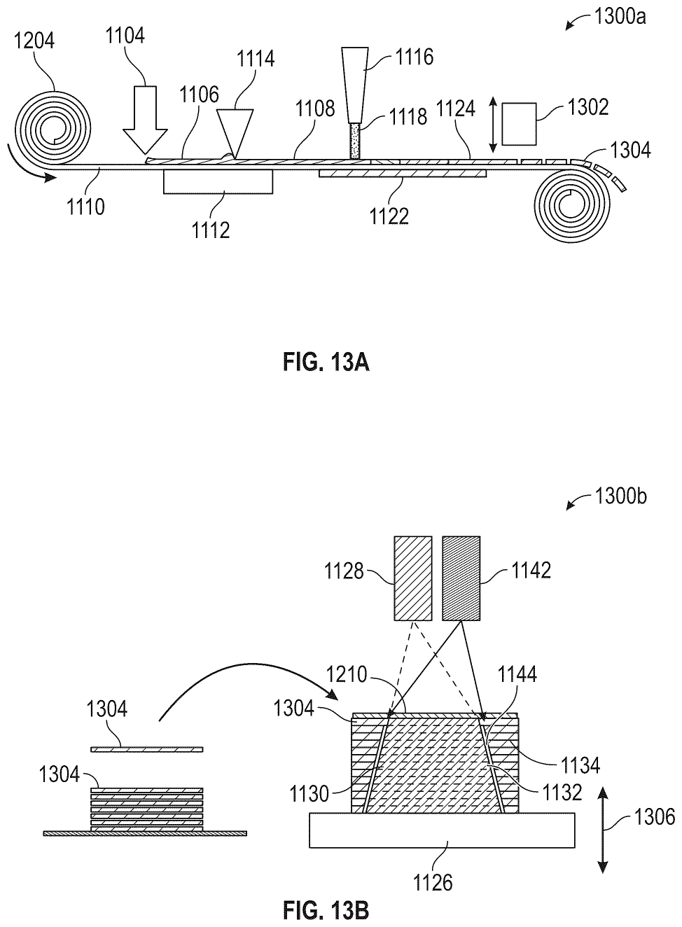

FIGS. 13A and 13B are partially schematic illustrations of processes for additive manufacturing of an object, in accordance with embodiments of the present technology. Specifically, FIG. 13A illustrates a first process phase 1300a in which a plurality of discrete sheets of material for additive manufacturing of the object are fabricated, and FIG. 12B illustrates a second process phase 1300b in which the object is formed from the prefabricated discrete sheets of material.

The first process phase 1300a of FIG. 13A is substantially similar to the first process phase 1200a illustrated in FIG. 12A, except as described below. In some embodiments, such as that illustrated by FIG. 13A, the first process phase 1300a includes a device 1302 that cuts the cold resin 1124 into discrete pieces (e.g., individual sheets). The device 1302 can be a die cutter, a laser cutter, a knife blade, or any other cutting device or mechanism. The cut pieces of solid resin 1304 are collected and provided to the second process phase 1300b. In some embodiments, the cut pieces remain on the carrier film 1110. In some embodiments the carrier film 1110 is also cut into pieces. In some embodiments, the resin injector 1104 and/or layer thickness controller 1114 are used to create separate pieces of resin 1124 with or without cutting device 1302.

In some embodiments, the individual pieces of solid resin 1304 are collected by a robotic arm. In some embodiments, the individual pieces of solid resin 1304 are sorted by stacking. In some embodiments, the stacked individual pieces of solid resin 1304 include a separating layer (e.g., a release liner) between pieces of solid resin 1304 to prevent the layers from sticking together. In certain embodiments, the adhesion promoter 1118 also prevents adhesion of pieces of solid resin 1304 to one another, for example, when stacked (e.g., by using an adhesion promoter that is a powder). In some embodiments, the pieces of solid resin 1304 are sorted by placing into a cartridge.

The pieces of solid resin 1304 are formed in the first process phase 1300a, and are then used in a second process phase 1300b during the formation of the 3D printed object 1130. The first process phase 1300a and second process phase 1300b can be separated by distance (e.g., each process can take place in separate locations or facilities) and/or can be separated in time (e.g., the pieces of solid resin 1304 can be formed in advance of its use in the second process phase 1300b). In this manner, the pieces of solid resin 1304 can be transportable (e.g., shipped to a manufacturing location) or stored until ready for use.

A plurality of pieces of solid resin 1304, e.g., in a stack or cartridge, are formed from the pieces of solid resin 1304 formed in the first process phase 1300a. In some embodiments, an adhesion promoter is applied between the pieces of solid resin or is applied to the pieces of solid resin after placement onto the build platform 1126 or printed object 1130. In the second process phase 1300b, the uncured pieces of solid resin 1304 are placed onto the build platform 1126 or subsequently placed in layers building on top of the previous resin layer. In some embodiments, a pick-and-place robot arm or other mechanism (not shown) is configured to place a piece of solid resin 1304 onto the build platform 1126 or on top of the previous resin layer.

In embodiments of the second process phase 1300b, a piece of solid resin 1304 is exposed to light from a light source 1128 curing the resin. Optionally, the second process phase 1300b includes a window 1210 between the light source 1128 and the piece of solid resin 1304. In some embodiments, the window 1210 is used to apply pressure to promote contact and/or adhesion of the solid resin 1304 with the previously deposited layer of solid resin 1304. In some embodiments, a roller (not shown) is used to apply pressure to promote contact and/or adhesion. In some embodiments, a window is not needed (e.g., if the pieces of solid resin 1304 are flat and/or there is high adhesion of the layers). Layers of the pieces of solid resin 1304 are successively deposited and cured through exposure to light from the light source 1128. In this manner, a printed object 1130 is formed from a plurality of resin layers, with each resin layer including a cured portion 1132 corresponding to a respective layer of the printed object 1130, and an uncured portion 1134 that is not intended to become part of the printed object 1130. The uncured portions 1134 can remain in place together with the cured portions 1132 throughout the additive manufacturing process. The uncured portions 1134 can act to support the printed object 1130, such that support structures for the printed object 1130 are not needed.

The second process phase 1300b can include means for moving the build platform relative to the unit containing the light source 1128 and window 1210 (if present). In some embodiments, the movement is vertical, e.g., as indicated by arrow 1306. In some embodiments, the movement is of the build platform 1126. In some embodiments, the movement is of the unit containing the light source 1128 and/or window 1210. In some embodiments, the light source 1128 can focus on each subsequent layer through a vertical distance that encompasses the total height of the printed object 1130.

In the second process phase 1300b, after each resin layer is deposited and cured, a cutting mechanism 1142 (e.g., a laser cutter, a blade, a blasting device, a milling device, or a waterjet cutter) is used to form one or more cuts 1144 in the resin layer at or near the boundary between the cured portion 1132 and the uncured portion 1134 of the resin layer. In some embodiments, the build platform 1126 is moved away from the unit including the light source 1128 and window 1210 (if present) to allow the cutting mechanism 1142 to access the resin layer. Alternatively, the build platform 1126 can remain stationary while the unit including the light source 1128 and window 1210 is moved away from the build platform 1126. Optionally, in embodiments where the cutting mechanism 1142 is a laser cutter, the laser energy can pass through the window 1210 (if present) to access the resin layer, such that the build platform 1126 and window 1210 need not be moved during the cutting process. In such embodiments, the material of the window 1210 can be selected to be partially or entirely transparent to the wavelength of the laser energy.

In some embodiments, the surface of pieces of solid resin 1304 and/or the surface of the 3D printed object 1130 are heated (e.g., with application of infrared light or exposure to a heating element, such as those further described elsewhere herein) to improve adhesion of layers of the solid resin 1304. In some embodiments, the adhesion of the resin layers is improved with application of an adhesive. In some embodiments, the pieces of solid resin 1304 have a low melting temperature. In some embodiments, the low melting temperature is low relative to the surrounding air temperature. In some embodiments, the pieces of solid resin 1304 have a low melting temperature such that pressure applied to the resin (e.g., pressure from the window 1210 pressing against the piece of solid resin 1304 during movement of the building build platform 1126) causes the resin to partially melt and thus adhere to the previously-deposited resin layer prior to light exposure.

The process of depositing a resin layer, curing the resin layer with the light source 1128, and forming cuts in the resin layer with the cutting mechanism 1142 can be repeated until the entire printed object 1130 is formed. The printed object 1130 can then be separated from the uncured portions 1134 along the cuts 1144 in the resin layers. The uncured portions 1134 can be recycled. As a non-limiting example, the uncured portions 1134 can be removed from the 3D printed object 1130 upon completion of the building of the printed object 1130, and can be re-heated and deposited into the first process phase 1300a via the resin injector 1104.

FIG. 14 is a partially schematic illustration of a system 1400 for additive manufacturing of an object, in accordance with embodiments of the present technology. The system 1400 includes a printhead 1402 that is used to build the 3D printed object 1130, e.g., without use of a carrier film or support structures at the build platform 1126. Unused resin can be recycled, and this embodiment can be configured for the production of individual layers comprising more than one material (e.g., the formation of multi-material single layers). The printhead 1402 includes an extruder 1404 (e.g., a die extruder), and a light source 1128. In some embodiments, the printhead 1402 includes a heater 1406. In some embodiments, the printhead 1402 includes a chiller 1408. In some embodiments, the extruder 1404 is configured to extrude and/or deposit film or resin. In some embodiments described herein, extruded films are produced. In some embodiments, a die-extruded film is produced.

As illustrated in FIG. 14, the printhead 1402 is configured to extrude melted hot resin 1108 from the extruder 1404 (e.g., extrudes hot resin 1108 in a similar manner as the resin injector 1104 extruding hot resin 1108 in FIGS. 11A-13B), thereby forming a resin layer in situ in a single pass. In some embodiments, the hot resin 1108 is a photopolymerizable resin. In some embodiments, the printhead 1402 includes a plurality of extruders 1404. In some embodiments, the plurality of extruders 1404 are configured to allow for multiple materials to be deposited (e.g., at least two extruders 1404 extruding different materials).

As illustrated in FIG. 14, in some embodiments the applied hot resin 1108 is cooled with the chiller 1408. In certain embodiments, cooling the hot resin 1108 with the chiller 1408 forms a cold resin 1124 (e.g., a solid or semi-solid resin), which may have distinct material properties when cured (as compared to the hot resin 1108 when cured). In some embodiments, the chiller 1408 is used to form a phase separated material. In some embodiments, the chiller 1408 is a cold blown air, a cold blown inert gas, or a sprayed liquid that rapidly evaporates and causes cooling (e.g., butane, liquid nitrogen, or CO₂ snow). In some embodiments, the chiller 1408 can be contact with a cold roller. In some embodiments, the chiller 1408 is a cooling plate (e.g., cooling plate 1122).

In some embodiments the printhead 1402 includes a heater 1406. In some embodiments, the resin is heated with the heater 1406 prior to exposure to the light source 1128. In some embodiments, the heater 1406 is an infrared heater configured to heat the resin with application of infrared irradiation. In some embodiments, heating the resin with the heater 1406 changes the properties of the resin and the resulting photopolymerized material.

The extruded resin is photopolymerized with exposure to the light source 1128. In some embodiments, exposing the resin to the light source 1128 described herein comprises digital light processing (DLP). In some embodiments, exposing the resin to the light source 1128 described herein comprises stereolithography (SLA).

In some embodiments, the system 1400 also includes means for moving the build platform 1126 vertically relative to the printhead 1402 (e.g., as indicated by arrow 1410). In some embodiments, the movement is of the build platform 1126. In some embodiments, the movement is of the printhead 1402. In some embodiments, the system 1400 also includes means for moving the printhead 1402 horizontally relative to the build platform 1126 (e.g., as indicated by arrow 1412). In this manner, the printhead 1402 and/or the build platform 1126 can be configured to move vertically (e.g., up and down), while the build platform 1126 moves horizontally (e.g., left and right, and/or forward and backward). In some embodiments, the printhead 1402, the build platform 1126, or any combination thereof can move in 1 spatial direction, 2 spatial directions (e.g., in a planar movement), or 3 spatial directions.

After each resin layer is deposited and cured, a cutting mechanism 1142 (e.g., a laser cutter, a blade, a blasting device, a milling device, or a waterjet cutter) can be used to form one or more cuts 1144 in the resin layer at or near the boundary between the cured portion 1132 and the uncured portion 1134 of the resin layer.

In some embodiments, the printhead 1402 further includes at least one device (not shown) configured to deposit material using ink jetting, spraying, extruding, pulsed liquid deposition (e.g., PICO Pμlse), powder deposition, toner powder deposition, etc. The device may be used to deposit material anywhere in the process flow, e.g., from before resin extrusion to after cutting.

The process of depositing a resin layer, curing the resin layer with the light source 1128, and forming cuts in the resin layer with the cutting mechanism 1142 can be repeated until the entire printed object 1130 is formed. In this manner, a printed object 1130 is formed from a plurality of resin layers, with each resin layer including a cured portion 1132 corresponding to a respective layer of the printed object 1130, and an uncured portion 1134 that is not intended to become part of the printed object 1130. The uncured portions 1134 can remain in place together with the cured portions 1132 throughout the additive manufacturing process. The uncured portions 1134 can act to support the printed object 1130, such that support structures for the printed object 1130 are not needed. The printed object 1130 can then be separated from the uncured portions 1134 along the cuts 1144 in the resin layers. The uncured portions 1134 can be recycled. As a non-limiting example, the uncured portions 1134 can be removed from the 3D printed object 1130 upon completion of the building of the printed object 1130, and can be re-heated and deposited into the extruder 1404.

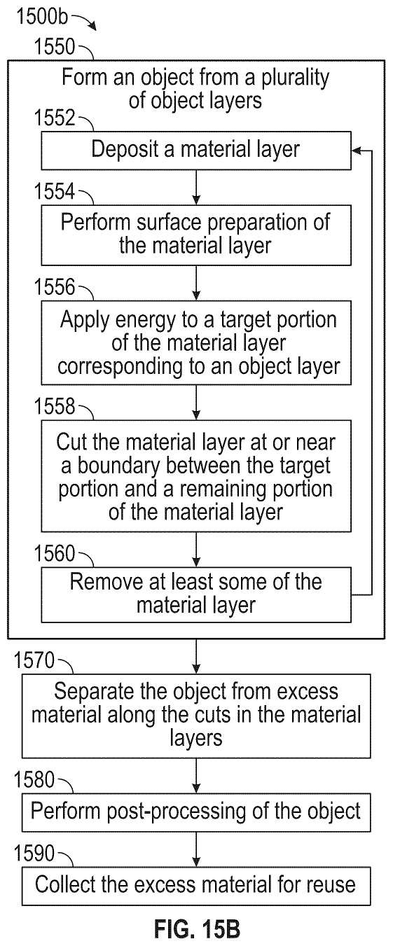

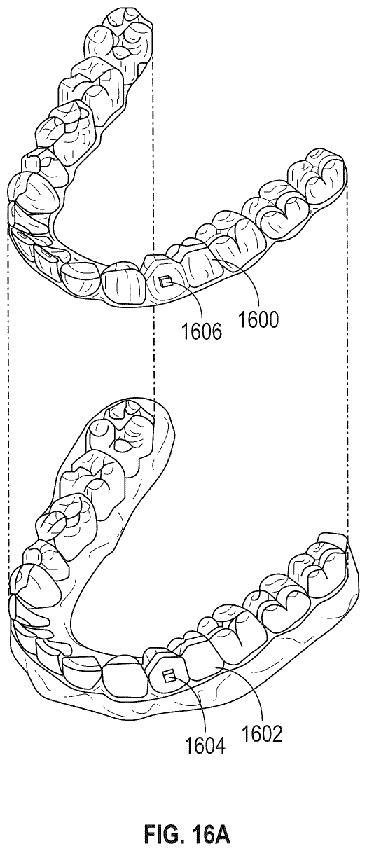

FIG. 15A is a flow diagram illustrating a method 1500a for fabricating an object, in accordance with embodiments of the present technology. The method 1500a can be performed by any embodiment of the systems and devices described herein, such any of the embodiments of FIGS. 1A-14. In some embodiments, some or all of the processes of the method 1500a are implemented as computer-readable instructions (e.g., program code) that are configured to be executed by one or more processors of a computing device, such a controller of an additive manufacturing system (e.g., the controller 112 of FIG. 1A).

The method 1500a can begin at block 1510 with forming an object from a plurality of object layers. In some embodiments, the object is a dental appliance, such as an aligner, retainer, palatal expander, attachment placement device, etc. Each object layer can be a respective cross-section, slice, etc., of the object. The object can be fabricated in a layer-by-layer additive manufacturing process in which each object layer is formed according to the processes of blocks 1512-1516.

At block 1512, the method 1500a can include depositing a material layer. The material layer can be deposited on a build platform (e.g., when forming the first layer of the object) or on a previously deposited material layer (e.g., when depositing subsequent layers of the object). The material layer can include any of the features described herein. For example, the material layer can be a resin including one or more polymerizable components and one or more optional additives. As another example, the material layer can be a polymerized material, such as a thermoplastic resin material. The material layer can be provided in a solid or semi-solid state. The material layer can be a prefabricated material (e.g., a continuous roll of material or a plurality of discrete sheets of material) or can be fabricated in situ (e.g., via extrusion). The material layer may be supported by another component (e.g., a carrier film) or may be unsupported.

At block 1514, the method 1500a can include applying energy to a target portion of the material layer. The target portion can have a geometry corresponding to the object layer to be formed. The energy can cause a change in at least one material property of the target portion, such as curing, polymerization, sintering, melting, fusing, and/or adhesion to an underlying material layer. For example, in embodiments where the material layer includes a curable material (e.g., a polymerizable resin), the energy can cause curing (e.g., polymerization and/or crosslinking) of the target portion of the material layer. As another example, in embodiments where the material layer includes a thermoplastic material, the energy can cause melting, fusing, and/or adhering of the thermoplastic material to an underlying material layer (e.g., via a bonding agent that is activated by the energy). The energy can include electromagnetic energy, such as light energy (e.g., UV light, visible, light, infrared light), thermal energy, microwave energy, x-ray energy, or a combination thereof. The energy can be applied by any suitable energy source, such as a laser, projector, light engine, LED, flash tube, digital micromirror device, or suitable combinations thereof. In some embodiments, the energy source is a DLP or SLA energy source.

At block 1516, the method 1500a can include cutting the material layer at or near a boundary between the target portion and a remaining portion of the material layer. The remaining portion can correspond to the parts of the material layer that are not intended to become part of the object (e.g., excess material). In some embodiments, the remaining portion is the part of the material layer that is substantially unaffected by the energy applied in block 1514, e.g., the remaining portion is not cured, polymerized, sintered, melted, fused, and/or adhered to an underlying material layer. This can be accomplished, for example, by selectively applying the energy to the target portion such that the remaining portion is not exposed to the energy, by selective application of an activating and/or bonding agent to the target portion only, and/or by selective application of an inhibiting agent to the remaining portion only.

The cut can be formed in the material layer to create a space, gap, groove, channel, etc., between the target portion and the remaining portion. The cut can be formed directly on the boundary between the target portion and the remaining portion, or can be offset from the boundary. The depth of the cut can be the same as, greater than, or less than the thickness of the material layer. Optionally, the cut may be formed in more than one material layer, such as through two or more layers. In some embodiments, the cut is formed using a cutting mechanism, such as a laser cutter, a blade, a blasting device, a milling device, a waterjet cutter, etc.

As shown in FIG. 15A, the processes of blocks 1512-1516 can be repeated to build up the object from a plurality of successive object layers. The composition, geometry, and deposition process of the material layer used for each object layer can be identical or can be varied as desired. The remaining (e.g., uncured) portion of each material layer can remain in place to support subsequently deposited material layers, thus allowing for formation of complex geometries such as overhangs, islands, internal cavities, etc., without requiring support structures. In some embodiments, some regions of the remaining portion are removed during the print, though other regions of the remaining portion that are being used as support may remain in place.

At block 1520, once the entire object has been fabricated, the method 1500a can include separating the object from excess material along the cuts in the material layers. For example, the excess material can include material that is not intended to be part of the final object and thus is not cured, polymerized, sintered, melted, fused, and/or adhered to an underlying layer during the processes of blocks 1512-1516. The excess material can be separated from the object using any suitable technique, as manual removal by a human operator, removal via mechanical forces (e.g., via a blade, scraper, brush, centrifuge), removal via solvents, removal via melting, or suitable combinations thereof. The presence of the cuts can facilitate removal of most or all of the excess material without requiring harsh solvents, large mechanical forces, and/or other processes that might otherwise damage the object.

At block 1530, the method 1500a can optionally include performing post-processing of the object. Such post-processing can include, for example, removing additional excess material from the object (e.g., via solvents, centrifugation), post-curing and/or annealing the object, and/or modifying the surfaces of the object (e.g., by applying a coating to the object).

At block 1540, the method 1500a can optionally include collecting the excess material for reuse. As described herein, the excess material can be substantially uncured, unpolymerized, unsintered, etc., and thus may be suitable for use in a subsequent additive manufacturing process. The excess material may be processed for reuse, such as by grinding or pelletizing the excess material, heating, melting, filtering, dissolving in a solvent, washing in a non-dissolving solvent, etc.

The method 1500a illustrated in FIG. 15A can be modified in many different ways. For example, although the above processes of the method 1500a are described with respect to a single object, the method 1500a can be used to sequentially or concurrently fabricate and post-process any suitable number of objects, such as tens, hundreds, or thousands of additively manufactured objects. As another example, the ordering of the processes shown in FIG. 15A can be varied, and/or some of the processes of the method 1500a can be omitted (e.g., the processes of blocks 1530 and 1540). In some embodiments, the processes of blocks 1514 and 1516 are switched in order. In some embodiments, the process of block 1516 may be omitted for one or more material layers and performed for one or more other material layers.

Moreover, the method 1500a can include processes not shown in FIG. 15A. In some embodiments, for instance, the method 1500a can further include placing another object into the printed object (e.g., in a cavity, hole, indention, channel, etc.). The object may be a wire (e.g., for electrical connectivity, mechanical support, and/or other purposes), a mesh, a foam (e.g., an open or closed cell foam), an electronic device, a battery, a sensor, a different material, a powder, a liquid, a rubber, an energy-absorbing material (e.g., mechanical, vibrational, optical, electrical), and/or other object or material. Such objects may be added using robotic arms, manually placed, injected, extruded, poured, dispensed, or otherwise incorporated into the printed object. This added process allows for the embedding of additional components into the printed object.

FIG. 15B is a flow diagram illustrating a method 1500b for fabricating an object, in accordance with embodiments of the present technology. The method 1500b can be performed by any embodiment of the systems and devices described herein, such any of the embodiments of FIGS. 1A-14. In some embodiments, some or all of the processes of the method 1500b are implemented as computer-readable instructions (e.g., program code) that are configured to be executed by one or more processors of a computing device, such a controller of an additive manufacturing system (e.g., the controller 112 of FIG. 1A).

The method 1500b can begin at block 1550 with forming an object from a plurality of object layers. In some embodiments, the object is a dental appliance, such as an aligner, retainer, palatal expander, attachment placement device, etc. Each object layer can be a respective cross-section, slice, etc., of the object. The object can be fabricated in a layer-by-layer additive manufacturing process in which each object layer is formed according to the processes of blocks 1552-1560.

At block 1552, the method 1500b can include depositing a material layer. The material layer can be deposited on a build platform (e.g., when forming the first layer of the object) or on a previously deposited material layer (e.g., when depositing subsequent layers of the object). The material layer can include any of the features described herein. For example, the material layer can be a resin including one or more polymerizable components and one or more optional additives. As another example, the material layer can be a polymerized material, such as a thermoplastic resin material. The material layer can be provided in a solid or semi-solid state. The material layer can be a prefabricated material (e.g., a continuous roll of material or a plurality of discrete sheets of material) or can be fabricated in situ (e.g., via extrusion). The material layer may be supported by another component (e.g., a carrier film) or may be unsupported.

At block 1554, the method 1500b can optionally include performing surface preparation of the material layer. For example, the surface preparation can include applying a bonding agent to a surface of the material layer to bond, weld, or otherwise adhere the material layer to a subsequent material layer. The bonding agent may or may not need to be activated by energy in order to produce interlayer adhesion. The bonding agent may be an adhesion promoter, infrared absorber, dye, pigment, solvent, plasticizer, etc., as described herein. As another example, the surface preparation can include applying an adhesion inhibitor to a surface of the material layer to reduce or prevent adhesion of the material layer to a subsequent material layer. The adhesion inhibitor may be a cure inhibitor and/or may prevent direct contact between selected portions of the material layer and the subsequent material layer. In a further example, the surface preparation can include removing a portion of the surface of the material layer to form a gap between the material layer and a subsequent material layer. The gap can prevent direct contact between selected portions of the material layer and the subsequent material layer to inhibit interlayer adhesions at those portions. Material removal may be performed using a cutting mechanism such as a laser cutter, a blade, a blasting device, a milling device, a waterjet cutter, etc. In some embodiments, the gap may be subsequently filled with a material to reduce or prevent adhesion.

At block 1556, the method 1500b can include applying energy to a target portion of the material layer. The target portion can have a geometry corresponding to the object layer to be formed. The energy can cause a change in at least one material property of the target portion, such as via curing, polymerization, sintering, melting, fusing, and/or adhesion to an underlying material layer. For example, in embodiments where the material layer includes a curable material (e.g., a polymerizable resin), the energy can cause curing (e.g., polymerization and/or crosslinking) of the target portion of the material layer. As another example, in embodiments where the material layer includes a thermoplastic material, the energy can cause melting, fusing, and/or adhering of the thermoplastic material to an underlying material layer (e.g., via a bonding agent that is activated by the energy). The energy can include electromagnetic energy, such as light energy (e.g., UV light, visible, light, infrared light), thermal energy, microwave energy, x-ray energy, or a combination thereof. The energy can be applied by any suitable energy source, such as a laser, projector, light engine, LED, flash tube, digital micromirror device, or suitable combinations thereof. In some embodiments, the energy source is or includes a DLP or SLA energy source.

At block 1558, the method 1500b can include cutting the material layer at or near a boundary between the target portion and a remaining portion of the material layer. The remaining portion can correspond to the parts of the material layer that are not intended to become part of the object (e.g., excess material). In some embodiments, the remaining portion is the part of the material layer that is substantially unaffected by the energy applied in block 1556, e.g., the remaining portion is not cured, polymerized, sintered, melted, fused, and/or adhered to an underlying material layer. This can be accomplished, for example, by selectively applying the energy to the target portion such that the remaining portion is not exposed to the energy, by selective application of an activating and/or bonding agent to the target portion only, and/or by selective application of an inhibiting agent to the remaining portion only.

The cut can be formed in the material layer to create a space, gap, groove, channel, etc., between the target portion and the remaining portion. The cut can be formed directly on the boundary between the target portion and the remaining portion, or can be offset from the boundary. The height or depth of the cut can be the same as, greater than, or less than the thickness of the material layer. Optionally, the cut may be formed in more than one material layer, such as through two or more layers. In some embodiments, the cut is formed using a cutting mechanism, such as a laser cutter, a blade, a blasting device, a milling device, a waterjet cutter, etc.

At block 1560, the method 1500b can optionally include removing at least some of the material layer. For instance, at least some of the remaining portion of the material layer can be removed, e.g., to form a cavity in the material layer. The cavity can be formed to reduce the amount of excess material to be removed in later processing and/or to create an internal cavity within the object geometry. In some embodiments, locations of the remaining portion of the material layer that are intended to support subsequently deposited material layers are not removed, while locations of the remaining portion that are not intended to provide such support may be removed. Optionally, some of the target portion of the material layer can be removed, e.g., to adjust the geometry of the object layer. In some embodiments, the cavity resulting from material removal is subsequently filled with a different material.

As shown in FIG. 15B, the processes of blocks 1552-1560 can be repeated to build up the object from a plurality of successive object layers. The composition, geometry, and deposition process of the material layer used for each object layer can be identical or can be varied as desired. The remaining (e.g., uncured) portion of each material layer can remain in place to support subsequently deposited material layers, thus allowing for formation of complex geometries such as overhangs, islands, internal cavities, etc., without requiring support structures.

At block 1570, once the entire object has been fabricated, the method 1500b can include separating the object from excess material along the cuts in the material layers. For example, the excess material can include material that is not intended to be part of the final object and thus is not cured, polymerized, sintered, melted, fused, and/or adhered to an underlying layer during the processes of blocks 1552-1560. The excess material can be separated from the object using any suitable technique, as manual removal by a human operator, removal via mechanical forces (e.g., via a blade, scraper, brush, centrifuge), removal via solvents, removal via melting, or suitable combinations thereof. The presence of the cuts can facilitate removal of most or all of the excess material without requiring harsh solvents, large mechanical forces, and/or other processes that might otherwise damage the object.

At block 1580, the method 1500b can optionally include performing post-processing of the object. Such post-processing can include, for example, removing additional excess material from the object (e.g., via solvents, centrifugation), post-curing and/or annealing the object, and/or modifying the surfaces of the object (e.g., by applying a coating to the object).

At block 1590, the method 1500b can optionally include collecting the excess material for reuse. As described herein, the excess material can be substantially uncured, unpolymerized, unsintered, etc., and thus may be suitable for use in a subsequent additive manufacturing process. The excess material may be processed for reuse, such as by grinding or pelletizing the excess material, heating, melting, filtering, dissolving in a solvent, washing in a non-dissolving solvent, etc.

The method 1500b illustrated in FIG. 15B can be modified in many different ways. For example, although the above processes of the method 1500b are described with respect to a single object, the method 1500b can be used to sequentially or concurrently fabricate and post-process any suitable number of objects, such as tens, hundreds, or thousands of additively manufactured objects. As another example, the ordering of the processes shown in FIG. 15B can be varied, e.g., the processes of blocks 1554, 1556, and 1558 can be performed in any order. Moreover, some of the processes can be repeated, e.g., the process of block 1556 can be performed two or more times for a single object layer, with a first energy application performed to cause adhesion of material layers (e.g., globally or at selected locations) and a second energy application performed to cause curing of material (e.g., globally or at selected locations). As another example, the process of block 1552 can be repeated to form composite materials for a single layer (e.g., two or more different materials for a single layer) and/or to filling gaps, channels, or cavities with a different material. In a similar manner, the process of block 1554 can be repeated more than once to fill gaps, channels, or cavities, and/or to add sublayers to provide different properties to the object. Some of the processes of the method 1500b can be omitted, such as the processes of blocks 1554, 1560, 1580, and/or 1590.

Moreover, the method 1500b can include processes not shown in FIG. 15B. In some embodiments, for instance, the method 1500b can further include placing another object into the printed object (e.g., in a cavity, hole, indention, channel, etc.). The object may be a wire (e.g., for electrical connectivity, mechanical support, and/or other purposes), a mesh, a foam (e.g., an open or closed cell foam), an electronic device, a battery, a sensor, a different material, a powder, a liquid, a rubber, an energy-absorbing material (e.g., mechanical, vibrational, optical, electrical), and/or other object or material. Such objects may be added using robotic arms, manually placed, injected, extruded, poured, dispensed, or otherwise incorporated into the printed object. This added process allows for the embedding of additional components into the printed object.

Although certain embodiments of the present technology are described in connection with additive manufacturing of objects from material layers in a solid or semi-solid state, this is not intended to be limiting. In some embodiments, the systems, methods, and devices herein are configured for additive manufacturing of objects from material layers that are in a fluid state, such as resins that are flowable at room temperature (e.g., 20° C. to 25° C.). In such embodiments, to prevent flowing of the deposited material outside of the boundaries for the material layer, the outer edges of the deposited material may be cured and/or solidified (e.g., via application of energy), and/or a barrier material may be placed around the outer edges of the deposited material (e.g., an extruded polymer filament). Moreover, the laser cutting mechanisms described herein may also produce curing and/or solidification of the deposited material proximate to the location of the cut, thus inhibiting flow of material into the cut.

### II. Dental Appliances and Associated Methods

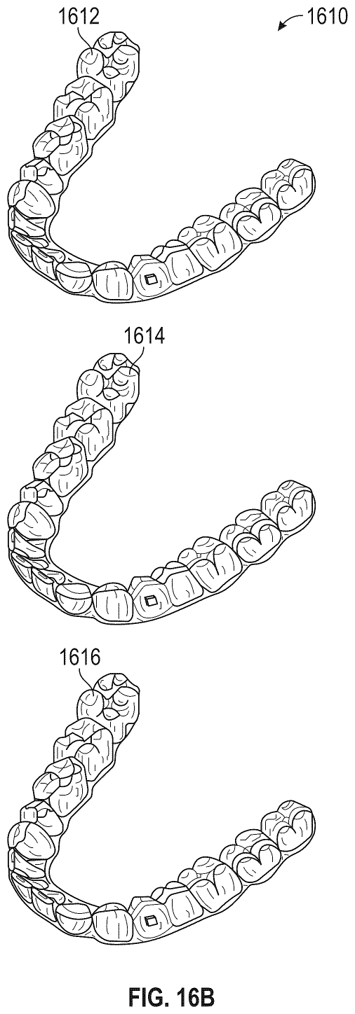

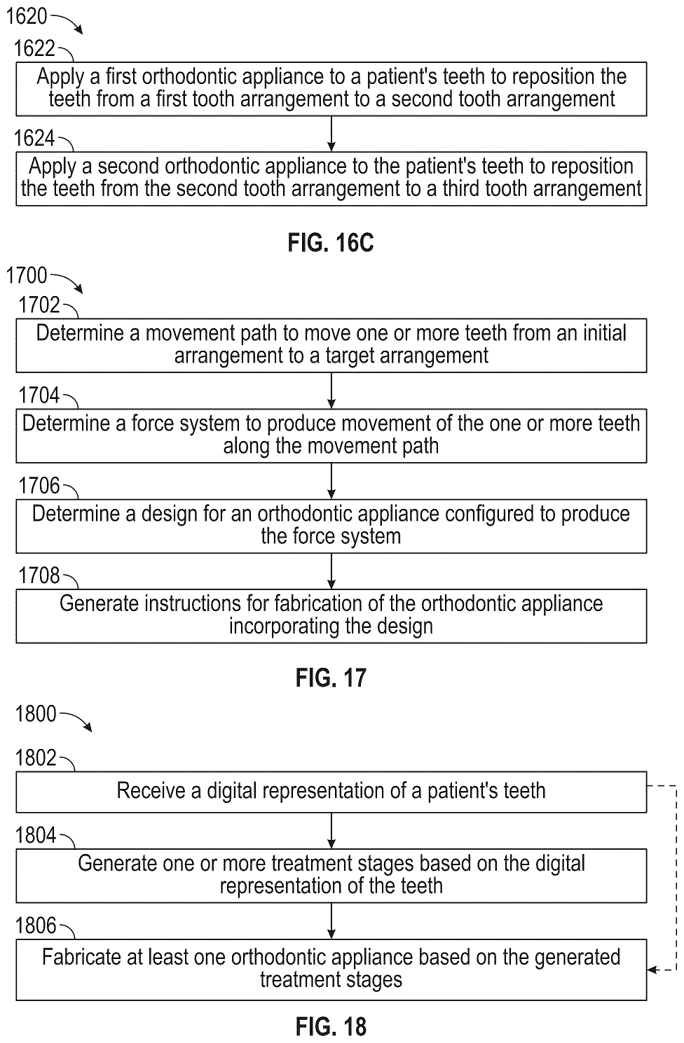

FIG. 16A illustrates a representative example of a tooth repositioning appliance 1600 configured in accordance with embodiments of the present technology. The appliance 1600 can be manufactured using any of the systems, methods, and devices described herein. The appliance 1600 (also referred to herein as an “aligner”) can be worn by a patient in order to achieve an incremental repositioning of individual teeth 1602 in the jaw. The appliance 1600 can include a shell (e.g., a continuous polymeric shell or a segmented shell) having teeth-receiving cavities that receive and resiliently reposition the teeth. The appliance 1600 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1600 can fit over all teeth present in an upper or lower jaw, or less than all of the teeth. The appliance 1600 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1600 can be a generic appliance configured to receive the teeth, but not necessarily shaped to match the topography of the patient's teeth. In some cases, only certain teeth received by the appliance 1600 are repositioned by the appliance 1600 while other teeth can provide a base or anchor region for holding the appliance 1600 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1600 in place over the teeth. In some cases, however, it may be desirable or necessary to provide individual attachments 1604 or other anchoring elements on teeth 1602 with corresponding receptacles 1606 or apertures in the appliance 1600 so that the appliance 1600 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 16B illustrates a tooth repositioning system 1610 including a plurality of appliances 1612, 1614, 1616, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1610 can include a first appliance 1612 corresponding to an initial tooth arrangement, one or more intermediate appliances 1614 corresponding to one or more intermediate arrangements, and a final appliance 1616 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 16C illustrates a method 1620 of orthodontic treatment using a plurality of appliances, in accordance with embodiments of the present technology. The method 1620 can be practiced using any of the appliances or appliance sets described herein. In block 1622, a first orthodontic appliance is applied to a patient's teeth in order to reposition the teeth from a first tooth arrangement to a second tooth arrangement. In block 1624, a second orthodontic appliance is applied to the patient's teeth in order to reposition the teeth from the second tooth arrangement to a third tooth arrangement. The method 1620 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

FIG. 17 illustrates a method 1700 for designing an orthodontic appliance, in accordance with embodiments of the present technology. The method 1700 can be applied to any embodiment of the orthodontic appliances described herein. Some or all of the steps of the method 1700 can be performed by any suitable data processing system or device, e.g., one or more processors configured with suitable instructions.

In block 1702, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1704, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1704 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1706, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1708, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the Instructions can be configured for indirect fabrication of the appliance, e.g., by thermoforming.

Although the above steps show a method 1700 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1700 may be performed with any suitable fabrication system or device, such as the embodiments described herein. Some of the steps may be optional, e.g., the process of block 1704 can be omitted, such that the orthodontic appliance is designed based on the desired tooth movements and/or determined tooth movement path, rather than based on a force system. Moreover, the order of the steps can be varied as desired.

FIG. 18 illustrates a method 1800 for digitally planning an orthodontic treatment and/or design or fabrication of an appliance, in accordance with embodiments. The method 1800 can be applied to any of the treatment procedures described herein and can be performed by any suitable data processing system.

In block 1802, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1804, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1806, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 18, design and/or fabrication of an orthodontic appliance, and perhaps a particular orthodontic treatment, may include use of a representation of the patient's teeth (e.g., including receiving a digital representation of the patient's teeth (block 1802)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The present technology is further illustrated by the following non-limiting examples.

### Example 1: Bonding of Thermoplastics Using Infrared Absorbers

This example describes studies to investigate whether two thermoplastic sheets could be bonded using an infrared (IR) absorber set as a pattern between the two sheets. Graphite or carbon black were used as an IR absorber and placed between two sheets of polycaprolactone (melting point of 60° C.). The sheets were warmed to 50° C., then a flash lamp was used to flash the sample with high intensity light. The areas that had the carbon black were bonded together. The areas that did not have the carbon black were not bonded. Only very small amounts of carbon black were needed, such that the sample was not black and only had a slight shaded grey appearance (only noticeable if compared with non-graphite treated samples). It is expected that other IR absorbers and/or other IR light sources could also work.

### Example 2: Laser Cutting of Thermoplastic Materials

This example describes studies to investigate use of a laser cutter to trace out a 2D object shape in a thermoplastic material layer. Two bonded layers of polycaprolactone (each 100 μm thick) were placed in a laser cutter. Various energy levels were tested until only one layer of material (100 μm) was cut by the laser. The layer below the layer that was cut was partially cut by the laser. However, the cut into the second layer was only 5 to 10 μm on average. This indicates that it is possible to mainly cut just one layer of material and only lightly cut into a second layer of material. The presence of an IR absorber (as would be used to bond two layers together) did not prevent the laser from cutting into the second layer in this experiment.

### Example 3: Bonding and Cutting of Thermoset Materials

This example describes studies to investigate whether a crosslinked thermoset material can be used and cut in a similar manner as the materials of Examples 1 and 2. A solid sheet of polycaprolactone diacrylate (Mn of 25 k) with 1 wt % diphenyl(2,4,6-trimethylbenzoyl)phosphine oxide (TPO) (about 100 μm thick) was placed on a metal grid. A 2D light pattern (365 nm light) was projected onto the sheet which caused the diacrylate to polymerize (even in the solid state). A solvent-dispersed carbon black solution was painted using a brush) on the exposed region (now crosslinked). The solvent was allowed to evaporate, leaving a very faint gray color on the areas that were painted. Then, a second sheet (unexposed) was then placed onto the first sheet and pressed lightly. The areas that had been painted appeared to wet the next layer when pressing the two layers together, which indicated that solvent welding alone may be enough to adhere the two layers together. An IR lamp source was used to irradiate the sample. The areas with the carbon black adhered, but a few other areas also adhered, potentially from hot spots on the IR source or from contaminants (such as carbon black). Next, the 365 nm light source was used to irradiate the second layer with the same pattern as was irradiated in the first layer.

The two fused layers were taken to the laser cutter and several laser power levels were tested until the amount needed to cut through one layer was determined. Then, the laser cutter was used to trace out the crosslinked areas. The laser cut through the second layer and slightly into the first layer (by about 15 μm). This demonstrated control of the laser cutter, but to get the part out, a second pass was performed to cut through the first layer as well. This demonstrated the ability to cut through more than one layer when desired.

The printed and laser cut object was removed from the uncured areas of the sheets. The printed object was then post-cured in a UV light box at 80° C. Upon removal and cooling, the part had excellent interlayer adhesion as demonstrated by trying to pull the two layers apart and having the material tear in a non-uniform way that was not dependent on where the layer was. This demonstrated that no solvent cleaning of the part is needed, since the laser cutter effectively trims the object from the uncured resin. The crosslinked material also retained its shape despite heating above its melting point (subsequent experimentation determined that it was not necessary to raise it above its melting point to get a good final cure in case accuracy concerns were present).

A second experiment was performed without the carbon black and IR lamp source; instead, only the UV curing was used, though lamination of the layers was performed at 50-53° C. There was good interlayer adhesion in the exposed areas and poor interlayer adhesion in unexposed areas. The laser cutter successfully cut the crosslinked material into the desired 2D shape; thus, carbon black was not necessary for either interlayer adhesion or laser cutting.

The uncured areas of the thermoset material from the above experiments were collected, melted, and cast back into sheets, and the curing experiment was repeated with the same results. These results indicate that the uncured material can be reused. It is expected that thermoplastic or thermoset materials can also be reused if the IR absorber (e.g., carbon black) is removed by washing. However, in production, an inkjet or other spatially controllable applicator may prevent contamination of areas outside the printed part and thus allow full reuse of the material.

### Example 4: Removal of Material Prior to Part Completion

Polycaprolactone tetramethacrylate (Mn of 25 k) was pressed into 100 μm sheets by a heat press and then allowed to cool. A sheet was placed on a build platform (50° C.) and allowed to warm up. A laser cutter was used to cut a circle pattern into the sheet (diameter of 2.54 cm). The external portion was removed to leave only the circle. A 365 nm light source was used to irradiate the sheet for 2 seconds (100 mW). A second sheet was then applied to the first cured circle and allowed to warm to 50° C. The laser cutter was again used to cut a circle (2.6 cm), and outside portions removed to leave the circle. The part was then irradiated. The process was repeated 10 times to produce an inverted pyramid-shaped part. The pyramid displayed some slight sagging, implying that the temperature was too close to the melting temperature (60° C.) for the polymer for it to be perfectly self-supporting.

The same experiment was repeated, this time leaving the uncured material in place but applying glass flake to the material outside of the cut circle using a brush. After 10 layers, the pyramid-shaped part was removed from the rest of the material with minimal effort. This demonstrated that other materials can be introduced to prevent adhesion in localized areas even if the full material sheet was cured during each layer. The interlayer adhesion of the pyramid was greatly improved by post curing in light at 55° C. No loss in shape occurred and no sagging from the overhang regions was evident.

### Additional Examples

The following examples are included to further describe some aspects of the present technology, and should not be used to limit the scope of the technology.

Clause 1. A method comprising:
forming an object from a plurality of object layers, wherein each object layer is formed by:
   depositing a material layer,
   applying energy to a target portion of the material layer, the target portion of the material layer having a geometry corresponding to the object layer, and
   forming a cut in the material layer at or near a boundary between the target portion of the material layer and a remaining portion of the material layer; and
after forming the object from the plurality of object layers, separating the object from excess material along the cut in each material layer.

Clause 2. The method of Clause 1, wherein the material layer comprises a curable material, and the energy causes curing of the target portion of the material layer.

Clause 3. The method of Clause 2, wherein the curable material comprises a polymerizable resin.

Clause 4. The method of Clause 2 or 3, wherein the remaining portion of the material layer is substantially uncured.

Clause 5. The method of any one of Clauses 1 to 4, wherein the material layer is deposited onto a previous material layer, and wherein the energy causes the target portion of the material layer to adhere to the previous material layer.

Clause 6. The method of Clause 5, wherein the target portion of the material layer adheres to a target portion of the previous material layer, the target portion of the previous material layer having a geometry corresponding to a previous object layer.

Clause 7. The method of Clause 5 or 6, wherein the remaining portion of the material layer is substantially unadhered to the previous material layer.

Clause 8. The method of any one of Clauses 5 to 7, further comprising applying a bonding agent to the previous material layer to facilitate adhesion to the target portion of the material layer.

Clause 9. The method of Clause 8, wherein the bonding agent is applied only to a portion of the previous material layer to be adhered to the target portion of the material layer.

Clause 10. The method of any one of Clauses 1 to 9, wherein the material layer comprises a thermoplastic material, a thermoset material, or a combination thereof.

Clause 11. The method of any one of Clauses 1 to 10, wherein the material layer comprises a solid material or a semi-solid material.

Clause 12. The method of any one of Clauses 1 to 11, wherein the material layer is formed in situ.

Clause 13. The method of Clause 12, wherein the material layer is formed by extrusion.

Clause 14. The method of any one of Clauses 1 to 11, wherein the material layer is prefabricated.

Clause 15. The method of Clause 14, wherein the material layer is part of a continuous roll of material.

Clause 16. The method of Clause 14, wherein the material layer is a discrete sheet of material.

Clause 17. The method of any one of Clauses 1 to 16, wherein the energy comprises light energy, heat energy, or a combination thereof.

Clause 18. The method of any one of Clauses 1 to 17, wherein the material layer is cut using one or more of laser cutting, blade cutting, blasting, milling, or waterjet cutting.

Clause 19. The method of any one of Clauses 1 to 18, wherein at least one object layer of the plurality of object layers comprises an overhang.

Clause 20. The method of Clause 19, wherein the overhang is formed by:
depositing a first material layer,
depositing a second material layer onto the first material layer, and
applying the energy to a target portion of the second material layer to form the overhang, wherein the energy produces a lower degree of curing of the overhang at or near the first material layer.

Clause 21. The method of Clause 19 or 20, wherein the overhang is formed by:
applying an adhesion inhibitor to a first material layer,
depositing a second material layer onto the first material layer, and
applying the energy to a target portion of the second material layer to form the overhang, wherein the adhesion inhibitor is between the overhang and the first material layer.

Clause 22. The method of any one of Clauses 19 to 21, wherein the overhang is formed by:
depositing a first material layer,
removing a portion of the first material layer,
depositing a second material layer onto the first material layer, and
applying the energy to a target portion of the second material layer to form the overhang, wherein the removal of the portion of the first material layer creates a gap between the overhang and the first material.

Clause 23. The method of any one of Clauses 1 to 22, further comprising controlling a temperature of the material layer using a heating device, a cooling device, or a combination thereof.

Clause 24. The method of any one of Clauses 1 to 23, further comprising performing a post-processing operation on the object.

Clause 25. The method of Clause 24, wherein the post-processing operation comprises one or more of centrifuging the object, post-curing the object, annealing the object, modifying a surface of the object, or washing the object.

Clause 26. The method of any one of Clauses 1 to 25, wherein the object is a dental appliance.

Clause 27. A fabrication system comprising:
one or more processors; and
a memory operably coupled to the one or more processors and storing instructions that, when executed by the one or more processors, cause the fabrication system to perform operations comprising the method of any one of Clauses 1 to 26.

Clause 28. A non-transitory computer-readable storage medium comprising instructions that, when executed by one or more processors of a fabrication system, cause the fabrication system to perform operations comprising the method of any one of Clauses 1 to 26.

Clause 29. A system for fabricating an object from a plurality of object layers, the system comprising:
a material source configured to deposit a material layer on a build platform or on a previous material layer;
an energy source configured to apply energy to a target portion of the material layer, the target portion of the material layer having a geometry corresponding to an object layer; and
a cutting mechanism configured to cut the material layer at or near a boundary between the target portion of the material layer and a remaining portion of the material layer, wherein the remaining portion of the material layer remains in place after cutting to support one or more subsequent material layers.

Clause 30. The system of Clause 29, wherein the material layer comprises a curable material, and the energy causes curing of the target portion of the material layer.

Clause 31. The system of Clause 30, wherein the remaining portion of the material layer is substantially uncured.

Clause 32. The system of any one of Clauses 29 to 31, wherein the material layer is deposited onto the previous material layer, and wherein the energy causes the target portion of the material layer to adhere to the previous material layer.

Clause 33. The system of Clause 32, wherein the target portion of the material layer adheres to a target portion of the previous material layer, the target portion of the previous material layer having a geometry corresponding to a previous object layer.

Clause 34. The system of Clause 32 or 33, wherein the remaining portion of the material layer is substantially unadhered to the previous material layer.

Clause 35. The system of any one of Clauses 32 to 34, further comprising an applicator configured to apply a bonding agent to the previous material layer to facilitate adhesion to the target portion of the material layer.

Clause 36. The system of Clause 35, wherein the bonding agent is applied only to a portion of the previous material layer to be adhered to the target portion of the material layer.

Clause 37. The system of any one of Clauses 29 to 36, wherein the material layer comprises a solid material or a semi-solid material.

Clause 38. The system of any one of Clauses 29 to 37, wherein the material source is configured to form the material layer in situ.

Clause 39. The system of Clause 38, wherein the material source comprises an extruder.

Clause 40. The system of any one of Clauses 29 to 39, wherein the material source is configured to deposit the material layer in a preformed state.

Clause 41. The system of Clause 40, wherein the material layer is part of a continuous roll of material.

Clause 42. The system of Clause 40, wherein the material layer is a discrete sheet of material.

Clause 43. The system of any one of Clauses 29 to 40, further comprising a carrier film configured to transport the material layer proximate to the build platform.

Clause 44. The system of Clause 43, wherein the carrier film is positioned between the energy source and the material layer.

Clause 45. The system of any one of Clauses 29 to 44, wherein the energy source comprises one or more of a light source or a heat source.

Clause 46. The system of any one of Clauses 29 to 45, wherein the cutting mechanism comprises one or more of a laser cutter, a blade, a blasting device, a milling device, or a waterjet cutter.

Clause 47. The system of any one of Clauses 29 to 46, further comprising a heating device configured to increase a temperature of the material layer.

Clause 48. The system of any one of Clauses 29 to 47, further comprising a cooling device configured to decrease a temperature of the material layer.

Clause 49. The system of any one of Clauses 29 to 48, wherein the material layer is deposited onto the previous material layer, and wherein the system further comprises an applicator configured to apply an adhesion inhibitor to the previous material layer to reduce adhesion to the material layer.

Clause 50. The system of any one of Clauses 29 to 49, wherein the material layer is deposited onto the previous material layer, and wherein the cutting mechanism is configured to remove a portion of the previous material layer to reduce adhesion to the material layer.

### Conclusion

Although many of the embodiments are described above with respect to systems, devices, and methods for manufacturing of dental appliances, the technology is applicable to other applications and/or other approaches, such as manufacturing of other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-18.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
forming an object from a plurality of object layers, wherein each object layer is formed by:
depositing a material layer,
applying energy to a target portion of the material layer, the target portion of the material layer having a geometry corresponding to the object layer, and
forming a cut in the material layer at or near a boundary between the target portion of the material layer and a remaining portion of the material layer; and
after forming the object from the plurality of object layers, separating the object from excess material along the cut in each material layer.

2. The method of claim 1, wherein the material layer comprises a curable material, and the energy causes curing of the target portion of the material layer.

3. The method of claim 2, wherein the curable material comprises a polymerizable resin.

4. The method of claim 2, wherein the remaining portion of the material layer is substantially uncured.

5. The method of claim 1, wherein the material layer is deposited onto a previous material layer, and wherein the energy causes the target portion of the material layer to adhere to the previous material layer.

6. The method of claim 5, wherein the target portion of the material layer adheres to a target portion of the previous material layer, the target portion of the previous material layer having a geometry corresponding to a previous object layer.

7. The method of claim 5, wherein the remaining portion of the material layer is substantially unadhered to the previous material layer.

8. The method of claim 5, further comprising applying a bonding agent to the previous material layer to facilitate adhesion to the target portion of the material layer.

9. The method of claim 8, wherein the bonding agent is applied only to a portion of the previous material layer to be adhered to the target portion of the material layer.

10. The method of claim 1, wherein the material layer comprises a solid material or a semi-solid material.

11. The method of claim 1, wherein the material layer is formed in situ.

12. The method of claim 11, wherein the material layer is formed by extrusion.

13. The method of claim 1, wherein the material layer is prefabricated.

14. The method of claim 1, wherein the energy comprises light energy, heat energy, or a combination thereof.

15. The method of claim 1, wherein the material layer is cut using one or more of laser cutting, blade cutting, blasting, milling, or waterjet cutting.

16. The method of claim 1, wherein at least one object layer of the plurality of object layers comprises an overhang.

17. The method of claim 16, wherein the overhang is formed by:
depositing a first material layer,
depositing a second material layer onto the first material layer, and
applying the energy to a target portion of the second material layer to form the overhang, wherein the energy produces a lower degree of curing of the overhang at or near the first material layer.

18. The method of claim 16, wherein the overhang is formed by:
applying an adhesion inhibitor to a first material layer,
depositing a second material layer onto the first material layer, and
applying the energy to a target portion of the second material layer to form the overhang, wherein the adhesion inhibitor is between the overhang and the first material layer.

19. The method of any one of claims 16, wherein the overhang is formed by:
depositing a first material layer,
removing a portion of the first material layer,
depositing a second material layer onto the first material layer, and
applying the energy to a target portion of the second material layer to form the overhang, wherein the removal of the portion of the first material layer creates a gap between the overhang and the first material.

20. The method of claim 1, wherein the object is a dental appliance.
